(19) United States
(12) Patent Application Publication
(10) Pub. No.: US 2015/0139303 A1
(43) Pub. Date: May 21, 2015

(54) ENCODING DEVICE, ENCODING METHOD, DECODING DEVICE, AND DECODING METHOD

(71) Applicant: SONY CORPORATION, Tokyo (JP)

(72) Inventor: Kazushi Sato, Kanagawa (JP)

(73) Assignee: SONY CORPORATION, Tokyo (JP)

(21) Appl. No.: 14/402,386

(22) PCT Filed: Jun. 21, 2013
(86) PCT No.: PCT/JP2013/067108

§ 371 Date: Nov. 20, 2014

(30) Foreign Application Priority Data
Jun. 29, 2012 (JP) 2012-147882

(51) Int. Cl. H04N 19/61; H04N 19/124

(52) U.S. Cl. CPC H04N 19/61; H04N 19/124
USPC 375/240.03; 375/240.12

(57) ABSTRACT

The present technology relates to an encoding device, an encoding method, a decoding device, and a decoding method that enable sign data hiding processing to be appropriately performed. An orthogonal transform unit orthogonally transforms a difference between an image to be encoded and a prediction image to generate orthogonal transform coefficients. A sign hiding encoding unit applies, based on a sum of absolute values of non-zero orthogonal transform coefficients of the orthogonal transform coefficients generated by the orthogonal transform unit, sign data hiding processing of deleting a sign of a head non-zero orthogonal transform coefficient, and correcting the non-zero orthogonal transform coefficients such that a parity of the sum of absolute values of non-zero orthogonal transform coefficients becomes a parity corresponding to the sign, to the orthogonal transform coefficients. The present technology can be applied to an encoding device, for example.

### TECHNICAL FIELD

The present technology relates to an encoding device, an encoding method, a decoding device, and a decoding method, and especially relates to an encoding device, an encoding method, a decoding device, and a decoding method that enable appropriate sign data hiding processing.

### BACKGROUND ART

Recently, devices have been spread both in broadcasting information from stations and in receiving information at homes, the devices taking image information as digital information, and adopting an encoding system such as Moving Picture Experts Group phase (MPEG) to compress the image information through orthogonal transformation such as discrete cosine transform, and motion compensation, using the redundancy specific to the image information, for the purpose of efficient information transmission and storage.

Especially, the MPEG2 (ISO/IEC 13818-2) system is defined as a general image encoding system, and is widely used as an application for professionals and for consumers because the system can treat both of interlaced scanned images and progressively scanned images, and standard resolution images and high resolution images. By use of the MPEG2 system, high encoding efficiency and high quality of images can be realized, for example, by assigning an amount of encoding (bit rate) of 4 to 8 Mbps to interlaced images of standard resolution of 720×480 pixels, and by assigning a bit rate of 18 to 22 Mbps to interlaced scanned images of high resolution of 1920×1088 pixels.

The MPEG2 system is mainly used for encoding of high quality of images for broadcasting, and does not cope with an amount of encoding (bit rate) lower than that used by the MPEG1 system. In short, the MPEG2 system does not cope with an encoding method with high encoding efficiency. With popularization of mobile terminals, high needs of such an encoding system are expected, and to respond to the needs, the MPEG4 encoding system was standardized. The MPEG4 encoding system for images was approved as international standard ISO/IEC 14496-2 in December 1998.

Further, in recent years, standardization of a standard called H.26L (ITU-T Q6/16 VCEG) has progressed, intended for encoding of images for video conferences. It is known that the H.26L realizes higher encoding efficiency, as compared to a conventional encoding system such as the MPEG2 or the MPEG4, although the H.26L requires greater computation amount for encoding and decoding.

Further, currently, as apart of activity of the MPEG4, standardization for taking an advantage of functions that are not supported by H.26L to realize higher encoding efficiency has been performed based on the H.26L as Joint Model of Enhanced-Compression Video Coding. This standardization was approved as international standard under the name of H.264 and MPEG-4 Part 10 (Advanced Video Coding (AVC)) in March 2003.

Further, as an expansion of the international standard, standardization of Fidelity Range Extension (FRExt) that includes encoding tools necessary for operations such as RGB, 4:2:2, and 4:4:4, 8×8 DCT stipulated in the MPEG-2, and quantization matrices has been completed in February 2005. Accordingly, an encoding format capable of favorably expressing film noises included in movies, AVC, has been obtained, and is to be used in a wide range of applications such as Blu-Ray (registered trademark) disc.

However, as of recent, there are increased needs for even higher compression encoding, such as to compress images around 4000×2000 pixels, which is fourfold that of Hi-Vision images, or to distribute Hi-Vision images in an environment with a limited transmission capacity, such as the Internet. Therefore, the Video Coding Expert Group (VCEG) under ITU-T continuously performs study related to improved encoding efficiency.

By the way, in the High Efficiency Video Coding (HEVC) system, sign data hiding processing has been proposed for orthogonal transform coefficients of residual information (for example, see Non-Patent Document 1). The sign data hiding processing is processing to delete a sign (±) of a head non-zero orthogonal transform coefficient, and correct the non-zero orthogonal transform coefficients such that a parity of a sum of absolute values of non-zero orthogonal transform coefficients becomes a parity corresponding to the sign of the head non-zero orthogonal transform coefficient.

Therefore, when the orthogonal transform coefficients after the sign data hiding processing are inversely orthogonally transformed, the sign of the head non-zero orthogonal transform coefficient of the orthogonal transform coefficients is determined by the parity of the sum of the absolute values of the non-zero orthogonal transform coefficients. To be specific, when the sum of the absolute values of the non-zero orthogonal transform coefficients is an even number, the sign of the head non-orthogonal transform coefficient is determined to be plus, and when the sum of the absolute values of the non-zero orthogonal transform coefficients is an odd number, the sign of the head non-orthogonal transform coefficient is determined to be minus.

The sign data hiding processing described in Non-Patent Document 1 is performed when free positions between the head non-zero orthogonal transform coefficient and the last non-zero orthogonal transform coefficient are larger than a predetermined number.

### CITATION LIST

### Non-Patent Document

### Non-Patent Document 1: Gardon CLARE, “Sign Data Hiding”, JCTVC-G271, 2011.11.21-30

### SUMMARY OF THE INVENTION

### Problems to be Solved by the Invention

However, influence of a quantization error due to application of the sign data hiding processing on the image quality differs depending on other factors than the number of free positions between the head non-zero orthogonal transform coefficient and the last non-zero orthogonal transform coefficient.

Therefore, as described in Non-Patent Document 1, when the sign data hiding processing is performed based on the number of free positions between the head non-zero orthogonal transform coefficient and the last non-zero orthogonal transform coefficient, the sign data hiding processing is even applied to an image that may have substantial deterioration of the image quality due to the sign data hiding processing, and deterioration of the image quality at a non-negligible level may be caused.

The present technology has been made in view of the foregoing, and is capable of appropriately performing the sign data hiding processing.

### Solutions to Problems

A first aspect of the present technology is an encoding device including: an orthogonal transform unit configured to orthogonally transform a difference between an image to be encoded and a prediction image to generate orthogonal transform coefficients; and a coefficient operation unit configured to apply, based on a sum of absolute values of non-zero orthogonal transform coefficients of the orthogonal transform coefficients generated by the orthogonal transform unit, sign data hiding processing of deleting a sign of a head non-zero orthogonal transform coefficient, and correcting the non-zero orthogonal transform coefficients such that a parity of the sum of absolute values of non-zero orthogonal transform coefficients becomes a parity corresponding to the sign, to the orthogonal transform coefficients.

An encoding method of the first aspect of the present technology corresponds to the encoding device of the first aspect of the present technology.

In the first aspect of the present technology, a difference between an image to be encoded and a prediction image are orthogonally transformed and orthogonal transform coefficients are generated, and sign data hiding processing of deleting, based on a sum of absolute values of non-zero orthogonal transform coefficients of the orthogonal transform coefficients, a sign of a head non-zero orthogonal transform coefficient, and correcting the non-zero orthogonal transform coefficients such that a parity of the sum of absolute values of non-zero orthogonal transform coefficients becomes a parity corresponding to the sign is performed for the orthogonal transform coefficients.

A second aspect of the present technology provides a decoding device including: a sign decoding unit configured to apply, based on a sum of absolute values of non-zero orthogonal transform coefficients of orthogonal transform coefficients of a difference between an image to be decoded and a prediction image, adding processing of adding a sign corresponding to a parity of the sum of absolute values of non-zero orthogonal transform coefficients as a sign of a head non-zero orthogonal transform coefficient, to the orthogonal transform coefficients; and an inverse orthogonal transform unit configured to inversely orthogonally transform the orthogonal transform coefficients subjected to the adding processing by the sign decoding unit.

A decoding method of the second aspect of the present technology corresponds to the decoding device of the second aspect of the present technology.

In the second aspect of the present technology, adding processing of adding, based on a sum of absolute values of non-zero orthogonal transform coefficients of orthogonal transform coefficients of a difference between an image to be decoded and a prediction image, a sign corresponding to a parity of the sum of absolute values of non-zero orthogonal transform coefficients as a sign of a head non-zero orthogonal transform coefficient is performed for the orthogonal transform coefficients, and the orthogonal transform coefficients subjected to the adding processing are inversely orthogonally transformed.

Note that the encoding devices of the first aspect and the second aspect can be realized by causing a computer to execute a program.

Further, the program executed by the computer in order to realize the encoding devices of the first aspect and the second aspect can be provided by being transmitted through a transmission medium or recorded in a recording medium.

### Effects of the Invention

According to the first aspect of the present technology, the sign data hiding processing can be appropriately performed.

Further, according to the second aspect of the present technology, an encoded stream appropriately subjected to the sign data hiding processing can be decoded.

### BRIEF DESCRIPTION OF DRAWINGS

FIG. 1 is a block diagram illustrating a configuration example of an embodiment of an encoding device to which the present technology is applied.

FIG. 2 is a block diagram illustrating a configuration example of an encoding unit of FIG. 1.

FIG. 3 is a block diagram illustrating a configuration example of a sign hiding encoding unit of FIG. 2.

FIG. 4 is a block diagram illustrating a configuration example of a sign hiding decoding unit of FIG. 2.

FIG. 5 is a diagram describing a CU.

FIG. 6 is a diagram illustrating an example of syntax that defines a Coef Group.

FIG. 7 is a diagram illustrating an example of syntax that defines a Coef Group.

FIG. 8 is a flowchart describing generation processing of the encoding device of FIG. 1.

FIG. 9 is a flowchart describing details of encoding processing of FIG. 8.

FIG. 10 is a flowchart describing details of the encoding processing of FIG. 8.

FIG. 11 is a flowchart describing details of sign hiding encoding processing of FIG. 9.

FIG. 12 is a flowchart describing details of sign hiding decoding processing of FIG. 10.

FIG. 13 is a block diagram illustrating a configuration example of an embodiment of a decoding device to which a present technology is applied.

FIG. 14 is a block diagram illustrating a configuration example of a decoding unit of FIG. 13.

FIG. 15 is a flowchart describing receiving processing by the decoding device of FIG. 13.

FIG. 16 is a flowchart describing details of decoding processing of FIG. 15.

FIG. 17 is a diagram illustrating an example of a multi-view image encoding system.

FIG. 18 is a diagram illustrating a principal configuration example of a multi-view image encoding device to which the present technology is applied.

FIG. 19 is a diagram illustrating a principal configuration example of a multi-view image decoding device to which the present technology is applied.

FIG. 20 is a diagram illustrating an example of a hierarchical image encoding system.

FIG. 21 is a diagram describing an example of spatial scalable encoding.

FIG. 22 is a diagram describing an example of temporal scalable encoding.

FIG. 23 is a diagram describing an example of scalable encoding of a signal-to-noise ratio.

FIG. 24 is a diagram illustrating a principal configuration example of a hierarchical image encoding device to which the present technology is applied.

FIG. 25 is a diagram illustrating a principal configuration example of a hierarchical image decoding device to which the present technology is applied.

FIG. 26 is a block diagram illustrating a configuration example of hardware of a computer.

FIG. 27 is a diagram illustrating a schematic configuration example of a television device to which the present technology is applied.

FIG. 28 is a diagram illustrating a schematic configuration diagram of a mobile phone to which the present technology is applied.

FIG. 29 is a diagram illustrating a schematic configuration example of a recording/reproducing device to which the present technology is applied.

FIG. 30 is a diagram illustrating a schematic configuration example of an imaging device to which the present technology is applied.

FIG. 31 is a block diagram illustrating an example of use of scalable encoding.

FIG. 32 is a block diagram illustrating another example of use of scalable encoding

FIG. 33 is a block diagram illustrating still another example of use of scalable encoding.

### MODE FOR CARRYING OUT THE INVENTION

### Embodiment

### Configuration Example of Embodiment of Encoding Device

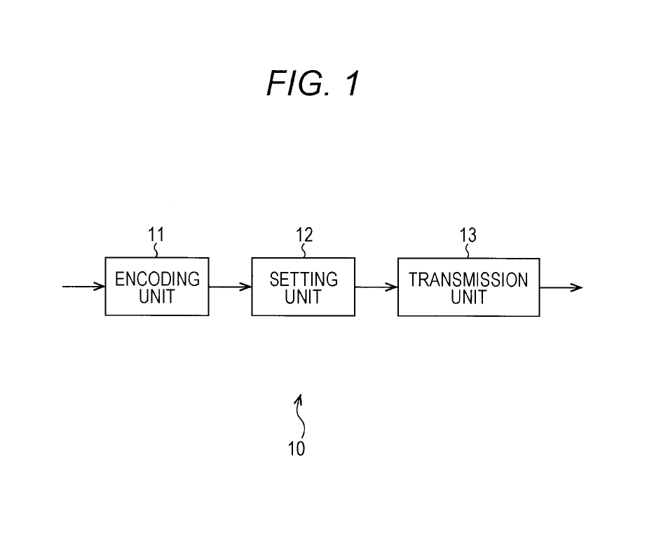

FIG. 1 is a block diagram illustrating a configuration example of an encoding device to which the present technology is applied.

An encoding device 10 of FIG. 1 is configured from an encoding unit 11, a setting unit 12, and a transmission unit 13, and encodes an image in the HEVC system.

To be specific, an image in frame units is input to the encoding unit 11 of the encoding device 10 as an input signal. The encoding unit 11 encodes the input signal in the HEVC system, and supplies encoded data obtained as a result of the encoding to the setting unit 12.

The setting unit 12 sets a sequence parameter set (SPS) that includes intra application information that indicates whether performing sign data hiding processing when an optimum prediction mode is an intra prediction mode, and inter application information that indicates whether performing sign data hiding processing when the optimum prediction mode is an inter prediction mode, according to a user input. Further, the setting unit 12 sets a picture parameter set (PPS), and the like.

The setting unit 12 generates an encoded stream from the set SPS and PPS, and the encoded data supplied from the encoding unit 11. The setting unit 12 supplies the encoded stream to the transmission unit 13.

The transmission unit 13 transmits the encoded stream supplied from the setting unit 12 to a decoding device described below.

### (Configuration Example of Encoding Unit)

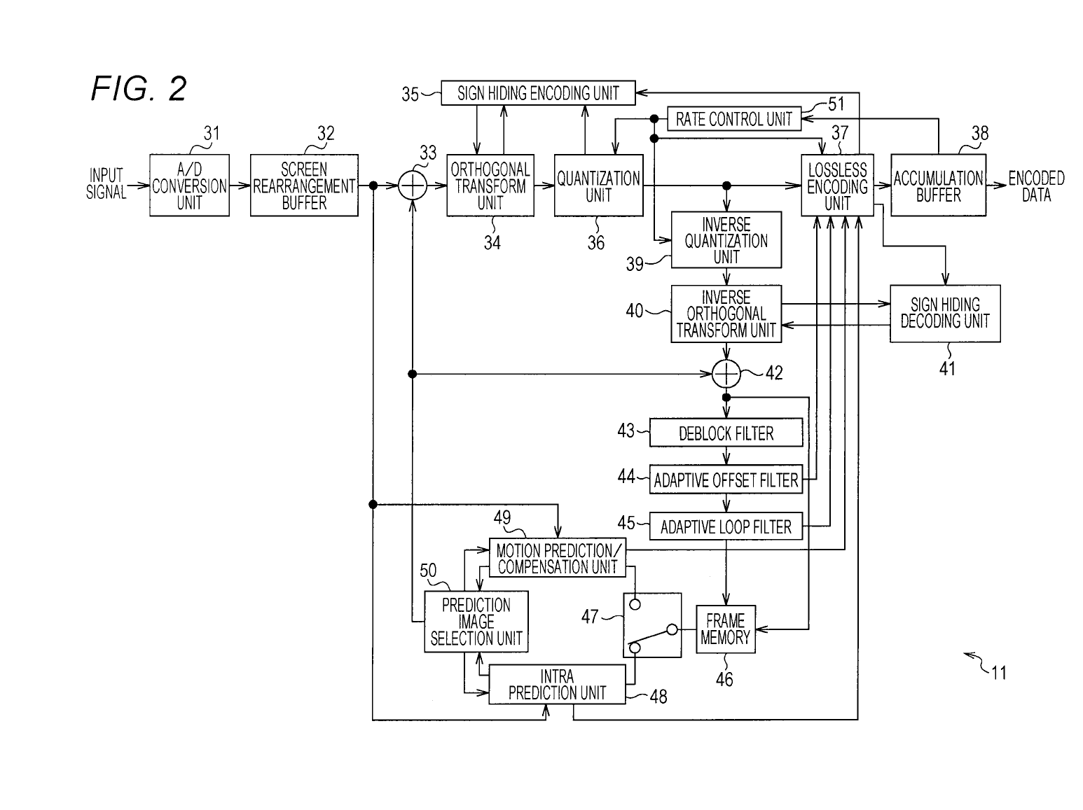

FIG. 2 is a block diagram illustrating a configuration example of the encoding unit 11 of FIG. 1.

The encoding unit 11 of FIG. 2 is configured from an A/D conversion unit 31, a screen rearrangement buffer 32, a computation unit 33, an orthogonal transform unit 34, a sign hiding encoding unit 35, a quantization unit 36, a lossless encoding unit 37, an accumulation buffer 38, an inverse quantization unit 39, an inverse orthogonal transform unit 40, a sign hiding decoding unit 41, an adding unit 42, a deblock filter 43, an adaptive offset filter 44, an adaptive loop filter 45, a frame memory 46, a switch 47, an intra prediction unit 48, a motion prediction/compensation unit 49, a prediction image selection unit 50, and a rate control unit 51.

To be specific, the A/D conversion unit 31 of the encoding unit 11 performs A/D conversion of an image in frame units input as an input signal, and outputs and stores the converted image in the screen rearrangement buffer 32. The screen rearrangement buffer 32 rearranges stored images in frame units in an order of display into an order for encoding, according to a group of picture (GOP) structure, and outputs the rearranged images to the computation unit 33, the intra prediction unit 48, and the motion prediction/compensation unit 49.

The computation unit 33 performs encoding by computing a difference between a prediction image supplied from the prediction image selection unit 50 and an image to be encoded output from the screen rearrangement buffer 32. To be specific, the computation unit 33 performs encoding by subtracting the prediction image supplied from the prediction image selection unit 50 from the image to be encoded output from the screen rearrangement buffer 32. The computation unit 33 outputs an image obtained as a result of the encoding to the orthogonal transform unit 34 as residual information. Note that, when the prediction image is not supplied from the prediction image selection unit 50, the computation unit 33 outputs the image read from the screen rearrangement buffer 32 to the orthogonal transform unit 34 as it is as the residual information.

The orthogonal transform unit 34 orthogonally transforms the residual information from the computation unit 33 to generate an orthogonal transform coefficient. The orthogonal transform unit 34 supplies the generated orthogonal transform coefficient to the sign hiding encoding unit 35, and supplies the orthogonal transform coefficient supplied from the sign hiding encoding unit 35 to the quantization unit 36.

The sign hiding encoding unit 35 applies sign data hiding processing to the orthogonal transform coefficient based on a quantization parameter from the quantization unit 36, prediction mode information that indicates an optimum prediction mode from the lossless encoding unit 37, and the orthogonal transform coefficient from the orthogonal transform unit 34. The sign hiding encoding unit 35 supplies the orthogonal transform coefficient subjected to the sign data hiding processing to the orthogonal transform unit 34.

The quantization unit 36 supplies a quantization parameter supplied from the rate control unit 51 to the sign hiding encoding unit 35. Further, the quantization unit 36 quantizes the orthogonal transform coefficient supplied from the orthogonal transform unit 34 using the quantization parameter supplied from the rate control unit 51. The quantization unit 36 inputs a coefficient obtained as a result of the quantization to the lossless encoding unit 37.

The lossless encoding unit 37 acquires information that indicates an adaptive intra prediction mode (hereinafter, referred to as intra prediction mode information) from the intra prediction unit 48. Further, the lossless encoding unit 37 acquires information that indicates an optimum inter prediction mode (hereinafter, referred to as inter prediction mode information), a motion vector, information for identifying a reference image, and the like from the motion prediction/compensation unit 49. Further, the lossless encoding unit 37 acquires the quantization parameter from the rate control unit 51.

The lossless encoding unit 37 supplies the intra prediction mode information or the inter prediction mode information to the sign hiding encoding unit 35 and the sign hiding decoding unit 41 as prediction mode information.

Further, the lossless encoding unit 37 supplies the quantization parameter to the sign hiding decoding unit 41.

Further, the lossless encoding unit 37 acquires a storage flag, an index or an offset, and type information from the adaptive offset filter 44 as offset filter information, and acquires a filter coefficient from the adaptive loop filter 45.

The lossless encoding unit 37 applies lossless encoding such as variable length encoding (for example, context-adaptive variable length coding (CAVLC)) and arithmetic encoding (for example, context-adaptive binary arithmetic coding (CABAC)) to the quantized coefficient supplied from the quantization unit 36.

Further, the lossless encoding unit 37 applies lossless encoding to the intra prediction mode information or the inter prediction mode information, the motion vector, the information for identifying a reference image, the quantization parameter, the offset filter information, and the filter coefficient, as encoding information related to encoding. The lossless encoding unit 37 supplies the encoding information and the coefficient subjected to the lossless encoding to the accumulation buffer 38 as encoded data, and accumulates the encoded data in the accumulation buffer 38. Note that the encoding information subjected to the lossless encoding may be served as header information of the coefficient subjected to the lossless encoding.

The accumulation buffer 38 temporarily stores the encoded data supplied from the lossless encoding unit 37. Further, the accumulation buffer 38 supplies the stored encoded data to the setting unit 12 of FIG. 1.

Further, the quantized coefficient output from the quantization unit 36 is also input to the inverse quantization unit 39. The inverse quantization unit 39 inversely quantizes the coefficient quantized by the quantization unit 36 using the quantization parameter supplied from the rate control unit 51, and supplies an orthogonal transform coefficient obtained as a result of the inverse quantization to the inverse orthogonal transform unit 40.

The inverse orthogonal transform unit 40 supplies the orthogonal transform coefficient supplied from the inverse quantization unit 39 to the sign hiding decoding unit 41, and inversely orthogonally transforms the orthogonal transform coefficient supplied from the sign hiding decoding unit 41. The inverse orthogonal transform unit 40 supplies residual information obtained as a result of the inverse orthogonal transform to the adding unit 42.

The sign hiding decoding unit 41 applies adding processing to the orthogonal transform coefficient based on the quantization parameter and the prediction mode information supplied from the lossless encoding unit 37 and the orthogonal transform coefficient supplied from the inverse orthogonal transform unit 40. The adding processing is processing of adding a sign corresponding to a parity of a sum of absolute values of non-zero orthogonal transform coefficients as a sign of a head non-zero orthogonal transform coefficient. The sign hiding decoding unit 41 supplies the orthogonal transform coefficient subjected to the adding processing to the inverse orthogonal transform unit 40.

The adding unit 42 adds the residual information supplied from the inverse orthogonal transform unit 40 and the prediction image supplied from the prediction image selection unit 50 to obtain a locally decoded image. Note that, when the prediction image is not supplied from the prediction image selection unit 50, the adding unit 42 employs the residual information supplied from the inverse orthogonal transform unit 40 as the locally decoded image. The adding unit 42 supplies the locally decoded image to the deblock filter 43, and supplies the locally decoded image to the frame memory 46 and accumulates the image therein.

The deblock filter 43 applies adaptive deblock filter processing of removing block distortion, to the locally decoded image supplied from the adding unit 42, and supplies an image obtained as a result of the processing to the adaptive offset filter 44.

The adaptive offset filter 44 applies adaptive offset filter (sample adaptive offset (SAO) processing of mainly removing ringing to the image subjected to the adaptive deblock filter processing by the deblock filter 43.

To be specific, the adaptive offset filter 44 determines a type of the adaptive offset filter processing for each largest coding unit (LCU) that is the maximum encoding unit, and obtains an offset used in the adaptive offset filter processing. The adaptive offset filter 44 applies the adaptive offset filter processing of the determined type to the image subjected to the adaptive deblock filter processing. Then, the adaptive offset filter 44 supplies an image subjected to the adaptive offset filter processing to the adaptive loop filter 45.

Further, the adaptive offset filter 44 includes a buffer that stores the offset. The adaptive offset filter 44 determines whether the offset used in the adaptive deblock filter processing has already been stored in the buffer for each LCU.

When having determined that the offset used in the adaptive deblock filter processing has already stored in the buffer, the adaptive offset filter 44 sets a storage flag that indicates whether the offset has already been stored in the buffer to a value (here, 1) that indicates that the offset has already been stored in the buffer.

Then, the adaptive offset filter 44 supplies the storage flag set to 1, an index that indicates a storage position of the offset in the buffer, and the type information that indicates the type of the performed adaptive offset filter processing to the lossless encoding unit 37, for each LCU.

Meanwhile, when the offset used in the adaptive deblock filter processing has not been stored in the buffer, the adaptive offset filter 44 stores the offsets in turn. Further, the adaptive offset filter 44 sets the storage flag to a value (here, 0) that indicates the offset has not been stored in the buffer. Then, the adaptive offset filter 44 supplies the storage flag set to 0, the offset, the type information to the lossless encoding unit 37, for each LCU.

The adaptive loop filter 45 applies adaptive loop filter (adaptive loop filter (ALF)) processing to the image subjected to the adaptive offset filter processing supplied from the adaptive offset filter 44, for each LCU. As the adaptive loop filter processing, for example, processing using two-dimensional Wiener filter is used. Of course, a filter other than the Wiener filter may be used.

To be specific, the adaptive loop filter 45 calculates a filter coefficient to be used in the adaptive loop filter processing such that a residual between an original image that is the image output from the screen rearrangement buffer 32 and an image subjected to the adaptive loop filter processing is minimized, for each LCU. Then, the adaptive loop filter 45 applies the adaptive loop filter processing to the image subjected to the adaptive offset filter processing using the calculated filter coefficient, for each LCU.

The adaptive loop filter 45 supplies an image subjected to the adaptive loop filter processing to the frame memory 46. Further, the adaptive loop filter 45 supplies the filter coefficient to the lossless encoding unit 37.

Note that, here, the adaptive loop filter processing is performed for each LCU. However, the processing unit of the adaptive loop filter processing is not limited to the LCU. Note that, by matching the processing units of the adaptive offset filter 44 and the adaptive loop filter 45, the processing can be efficiently performed.

The frame memory 46 accumulates the image supplied from the adaptive loop filter 45 and the image supplied from the adding unit 42. The images accumulated in the frame memory 46 are output to the intra prediction unit 48 or the motion prediction/compensation unit 49 through the switch 47 as reference images.

The intra prediction unit 48 performs intra prediction processing in all of candidate intra prediction modes using the reference images read from the frame memory 46 through the switch 47.

Further, the intra prediction unit 48 calculates a cost function value (details will be described below) for all of the candidate intra prediction modes, based on the image read from the screen rearrangement buffer 32 and the prediction image generated as a result of the intra prediction processing. Then, the intra prediction unit 48 determines an intra prediction mode having a minimum cost function value as the adaptive intra prediction mode.

The intra prediction unit 48 supplies the prediction image generated in the adaptive intra prediction mode and the corresponding cost function value to the prediction image selection unit 50. When selection of the prediction image generated in the adaptive intra prediction mode is notified from the prediction image selection unit 50, the intra prediction unit 48 supplies the intra prediction mode information to the lossless encoding unit 37.

Note that the cost function value is also called rate distortion (RD) cost, and is calculated based on a technique of either the High Complexity mode or the Low Complexity mode determined in the Joint Model (JM), which is reference software in the H.264/AVC system, for example.

To be specific, when the High Complexity mode is employed as the technique to calculate the cost function value, processing up to decoding is temporarily performed in all of candidate prediction modes, and the cost function value expressed by the next formula (1) is calculated for each of the prediction modes.

Cost (Mode)=D+λ·R (1)

D is a difference (distortion) between the original image and the decoded image, R is an occurring amount of encoding including up to the orthogonal transform coefficient, and λ is a Lagrange multiplier given as a function of a quantization parameter QP.

Meanwhile, when the Low Complexity mode is employed as the technique to calculate the cost function value, generation of the prediction image and calculation of the amount of encoding of the encoding information are performed in all of candidate prediction modes, and the cost function expressed by the next formula (2) is calculated for all of the prediction modes.

Cost (Mode)=D+QPtoQuant(QP)·Header_Bit (2)

D is a difference (distortion) between the original image and the prediction image, Header_Bit is the amount of encoding of the encoding information, and QPtoQuant is a function given as a function of a quantization parameter QP.

In the Low Complexity mode, only generation of the prediction mode is enough and generation of a decoded image is not necessary for all of the prediction modes, and thus the computation amount is small.

The motion prediction/compensation unit 49 performs prediction/compensation processing of all of candidate inter prediction modes. To be specific, the motion prediction/compensation unit 49 detects motion vectors of all of candidate inter prediction modes based on the image supplied from the screen rearrangement buffer 32 and the reference image read from the frame memory 46 through the switch 47. Then, the motion prediction/compensation unit 49 applies compensation processing to the reference image based on the motion vectors to generate the prediction image.

At this time, the motion prediction/compensation unit 49 calculates the cost function values for all of candidates inter prediction modes based on the image supplied from the screen rearrangement buffer 32 and the prediction image, and determines an inter prediction mode having a minimum cost function value as the optimum inter measurement mode. Then, the motion prediction/compensation unit 49 supplies the cost function value of the optimum inter prediction mode and the corresponding prediction image to the prediction image selection unit 50. Further, when having been notified selection of the prediction image generated in the optimum inter prediction mode from the prediction image selection unit 50, the motion prediction/compensation unit 49 outputs the inter prediction mode information, a corresponding motion vector, the information that identifies the reference image, and the like to the lossless encoding unit 37.

The prediction image selection unit 50 determines one of the adaptive intra prediction mode and the optimum inter prediction mode, the one having a smaller corresponding cost function value, as the optimum prediction mode, based on the cost function values supplied from the intra prediction unit 48 and the motion prediction/compensation unit 49. Then, the prediction image selection unit 50 supplies the prediction image of the optimum prediction mode to the computation unit 33 and the adding unit 42. Further, the prediction image selection unit 50 notifies the intra prediction unit 48 or the motion prediction/compensation unit 49 of selection of the prediction image of the optimum prediction mode.

The rate control unit 51 determines a quantization parameter to be used in the quantization unit 36 such that overflow or underflow does not occur, based on the encoded data accumulated in the accumulation buffer 38. The rate control unit 51 supplies the determined quantization parameter to the quantization unit 36, the lossless encoding unit 37, and the inverse quantization unit 39.

### (Configuration Example of Sign Hiding Encoding Unit)

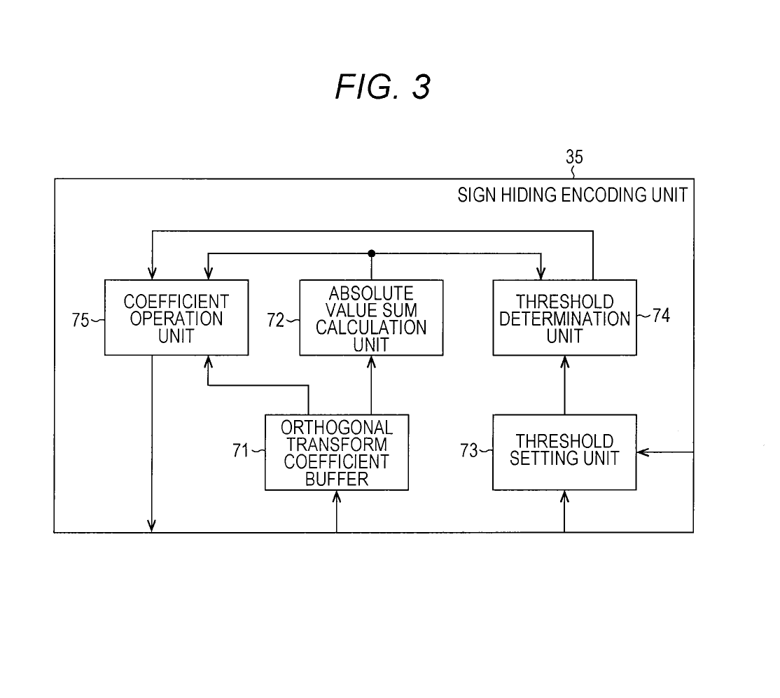

FIG. 3 is a block diagram illustrating a configuration example of the sign hiding encoding unit 35 of FIG. 2.

The sign hiding encoding unit 35 of FIG. 3 is configured from an orthogonal trans form coefficient buffer 71, an absolute value sum calculation unit 72, a threshold setting unit 73, a threshold determination unit 74, and a coefficient operation unit 75.

The orthogonal transform coefficient buffer 71 of the sign hiding encoding unit 35 stores the orthogonal transform coefficient supplied from the orthogonal transform unit 34. The absolute value sum calculation unit 72 reads non-zero orthogonal transform coefficients from the orthogonal transform coefficient buffer 71, calculates a sum of absolute values of the non-zero orthogonal transform coefficients, and supplies the sum to the threshold determination unit 74 and the coefficient operation unit 75.

The threshold setting unit 73 generates intra application information and inter application information according to a user input. The threshold setting unit 73 determines whether performing sign data hiding processing, based on the prediction mode information, the intra application information, and the inter application information supplied from the lossless encoding unit 37. When having determined to perform the sign data hiding processing, the threshold setting unit 73 sets a threshold such that the threshold becomes larger as the quantization parameter is larger, based on the quantization parameter supplied from the quantization unit 36. The threshold setting unit 73 supplies the set threshold to the threshold determination unit 74.

When the threshold is not supplied from the threshold setting unit 73, the threshold determination unit 74 generates a control signal that indicates not performing of the sign data hiding processing as a control signal that indicates whether performing the sign data hiding processing, and supplies the control signal to the coefficient operation unit 75. Meanwhile, when the threshold is supplied from the threshold setting unit 73, the threshold determination unit 74 compares the sum supplied from the absolute value sum calculation unit 72 and the threshold, and generates a control signal based on a comparison result. The threshold determination unit 74 supplies the generated control signal to the coefficient operation unit 75.

The coefficient operation unit 75 reads the orthogonal transform coefficients from the orthogonal transform coefficient buffer 71. When the control signal supplied from the threshold determination unit 74 indicates performing of the sign data hiding processing, the coefficient operation unit 75 applies the sign data hiding processing to the read orthogonal transform coefficients.

To be specific, the coefficient operation unit 75 corrects the non-zero orthogonal transform coefficients of the read orthogonal transform coefficients such that a parity of the sum of the absolute values of the non-zero orthogonal transform coefficients becomes a parity corresponding to a sign of a head non-zero orthogonal transform coefficient, based on the sun supplied from the absolute value sum calculation unit 72. The correction method is a method of adding ±1 to any of the non-zero orthogonal transform coefficients. Then, the coefficient operation unit 75 deletes the sign of the head non-zero orthogonal transform coefficient of the orthogonal transform coefficients after correction, and supplies the orthogonal trans form coefficients to the orthogonal transform unit 34 of FIG. 2.

Meanwhile, when the control signal supplied from the threshold determination unit 74 indicates not performing of the sign data hiding processing, the coefficient operation unit 75 supplies the read orthogonal transform coefficients to the orthogonal transform unit 34 as they are.

### (Configuration Example of Sign Hiding Decoding Unit)

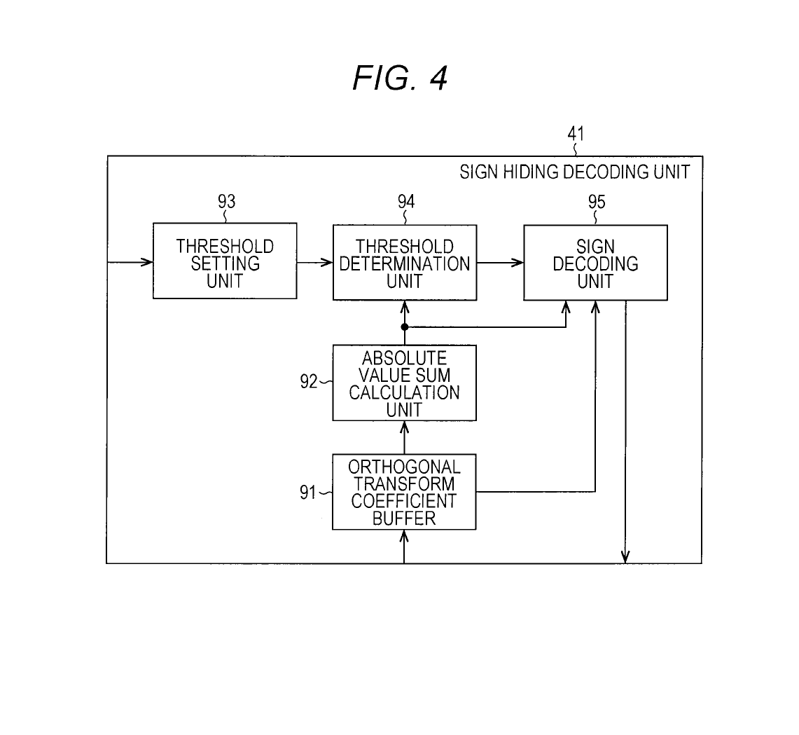

FIG. 4 is a block diagram illustrating a configuration example of the sign hiding decoding unit 41 of FIG. 2.

The sign hiding decoding unit 41 of FIG. 4 is configured from an orthogonal transform coefficient buffer 91, an absolute value sum calculation unit 92, a threshold setting unit 93, a threshold determination unit 94, and a sign decoding unit 95.

The orthogonal transform coefficient buffer 91 of the sign hiding decoding unit 41 stores the orthogonal transform coefficient supplied from the inverse orthogonal transform unit 40 of FIG. 2. The absolute value sum calculation unit 92 reads non-zero orthogonal transform coefficients from the orthogonal transform coefficient buffer 91, calculates a sum of absolute values of the non-zero orthogonal transform coefficients, and supplies the sum to the threshold determination unit 94 and the sign decoding unit 95.

The threshold setting unit 93 generates intra application information and inter application information according to a user input and the like. The threshold setting unit 93 determines whether performing the sign data hiding processing based on the prediction mode information, the intra application information, and the inter application information supplied from the lossless encoding unit 37. When having determined to perform the sign data hiding processing, the threshold setting unit 93 sets a threshold based on the quantization parameter supplied from the lossless encoding unit 37, similarly to the threshold setting unit 73. The threshold setting unit 93 supplies the set threshold to the threshold determination unit 94.

When the threshold is not supplied from the threshold setting unit 93, the threshold determination unit 94 supplies a control signal that indicates not performing of the adding processing to the sign decoding unit 95 as a control signal that indicates whether performing the adding processing. Meanwhile, when the threshold is supplied from the threshold setting unit 93, the threshold determination unit 94 compares the sum supplied from the absolute value sum calculation unit 92 and the threshold, and generates a control signal based on a comparison result. The threshold determination unit 94 supplies the generated control signal to the sign decoding unit 95.

The sign decoding unit 95 reads orthogonal transform coefficients from the orthogonal transform coefficient buffer 91. When the control signal supplied from the threshold determination unit 94 indicates performing of the adding processing, the sign decoding unit 95 applies the adding processing to the read orthogonal transform coefficients. To be specific, the sign decoding unit 95 adds a sign corresponding to a parity of the sum supplied from the absolute value sum calculation unit 92 to a head non-zero orthogonal transform coefficient of the read orthogonal transform coefficients as a sign of the head non-zero orthogonal transform coefficient. Then, the sign decoding unit 95 supplies the orthogonal transform coefficient subjected to the adding processing to the inverse orthogonal transform unit 40 of FIG. 2.

Meanwhile, when the control signal supplied from the threshold determination unit 94 indicates not performing of the adding processing, the sign decoding unit 95 supplies the read orthogonal transform coefficients to the inverse orthogonal transform unit 40 as they are.

### (Description of Encoding Processing Unit)

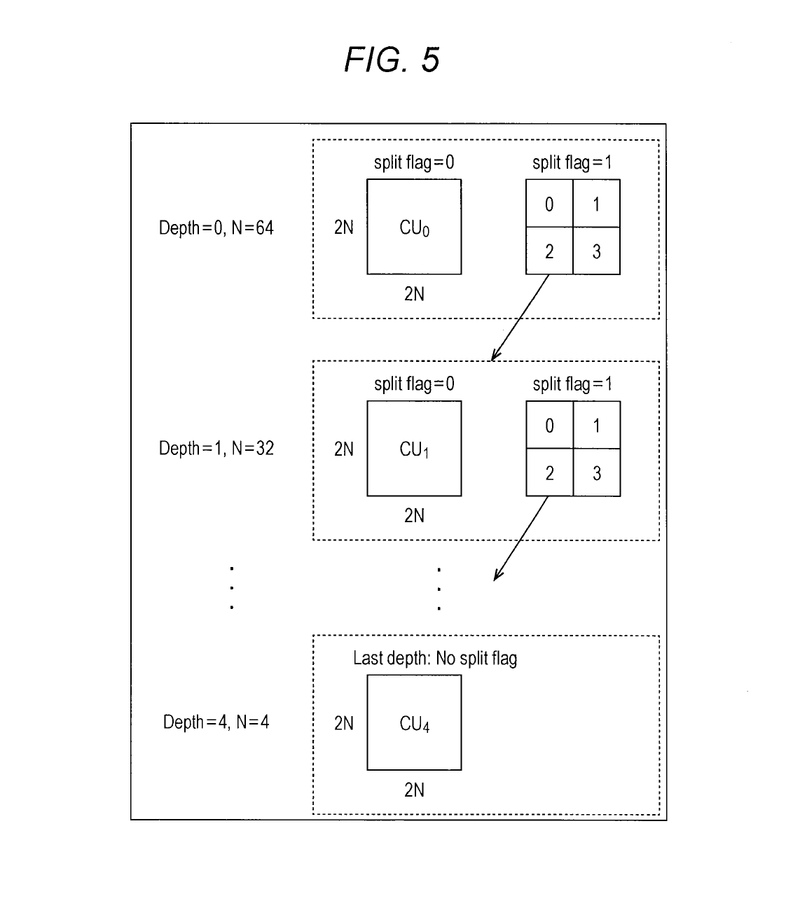

FIG. 5 is a diagram describing a coding unit (CU) that is an encoding unit in the encoding unit 11.

The CU plays a similar role to a macroblock in the AVC system. To be specific, the CU is divided into prediction units (PUs) that are units of intra prediction or inter prediction, or transform units (TUs) that are units of orthogonal transform. In the HEVC system, not only 4×4 pixels or 8×8 pixels but also 16×16 pixels or 32×32 pixels can be used as the size of the TU.

Note that while the size of the macroblock is fixed to 16×16 pixels, the size of the CU is a square expressed by pixels of the power of 2, which are variable for each sequence.

In the example of FIG. 5, the size of the largest coding unit (LCU) that is a CU having the maximum size is 128, and the size of a smallest coding unit (SCU) that is a CU having the minimum size is 8. Therefore, the hierarchical depth (depth) of the CU having the size of 2N×2N, which is hierarchized by each N, is 0 to 4, and the number of hierarchical depth is 5. Further, when the value of split flag is 1, the CU having the size of 2N×2N is divided into the CU having the size of N×N, which is one lower layer in the hierarchy.

Information that specifies the size of the CU is included in the SPS. Note that details of the CU are described in the HEVC text specification draft 7. Note that, in this specification, a coding tree unit (CTU) is a unit including a parameter of when processing is performed with coding tree blocks (CTBs) of the LCU and its LCU base (level). Further, the CU that configures the CTU is a unit including a parameter of when processing is performed with coding blocks (CBs) and its CU base (level).

### (Description of Unit of Sign Data Hiding Processing)

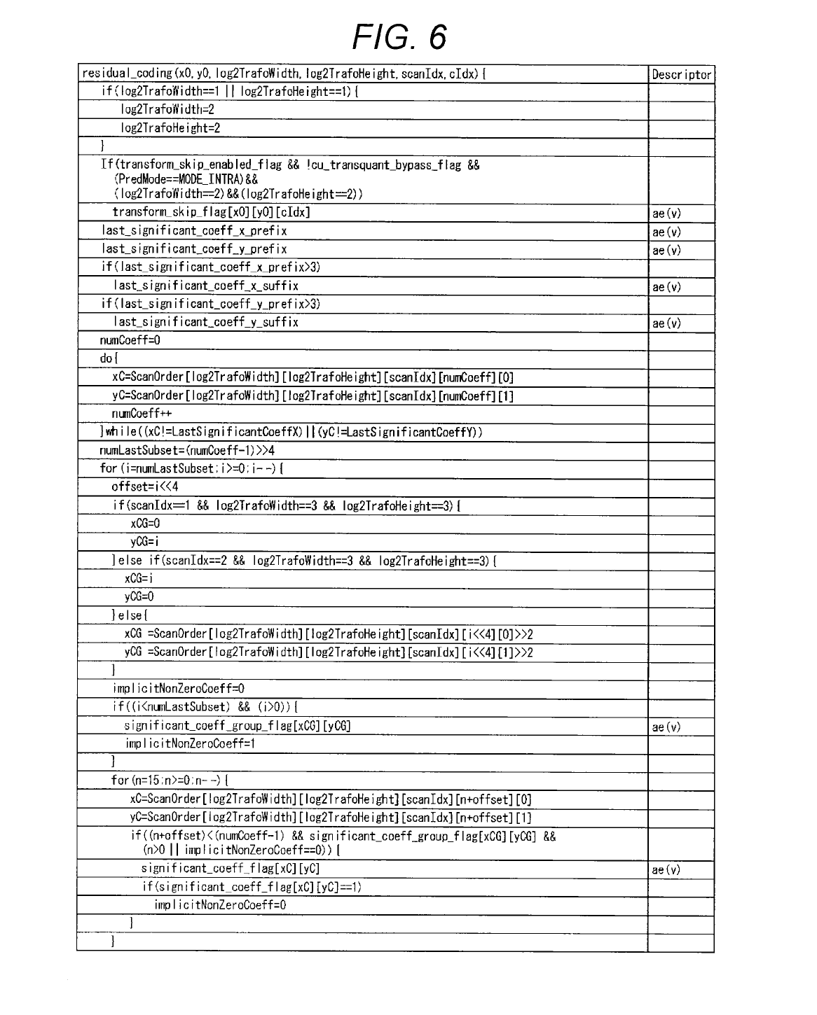

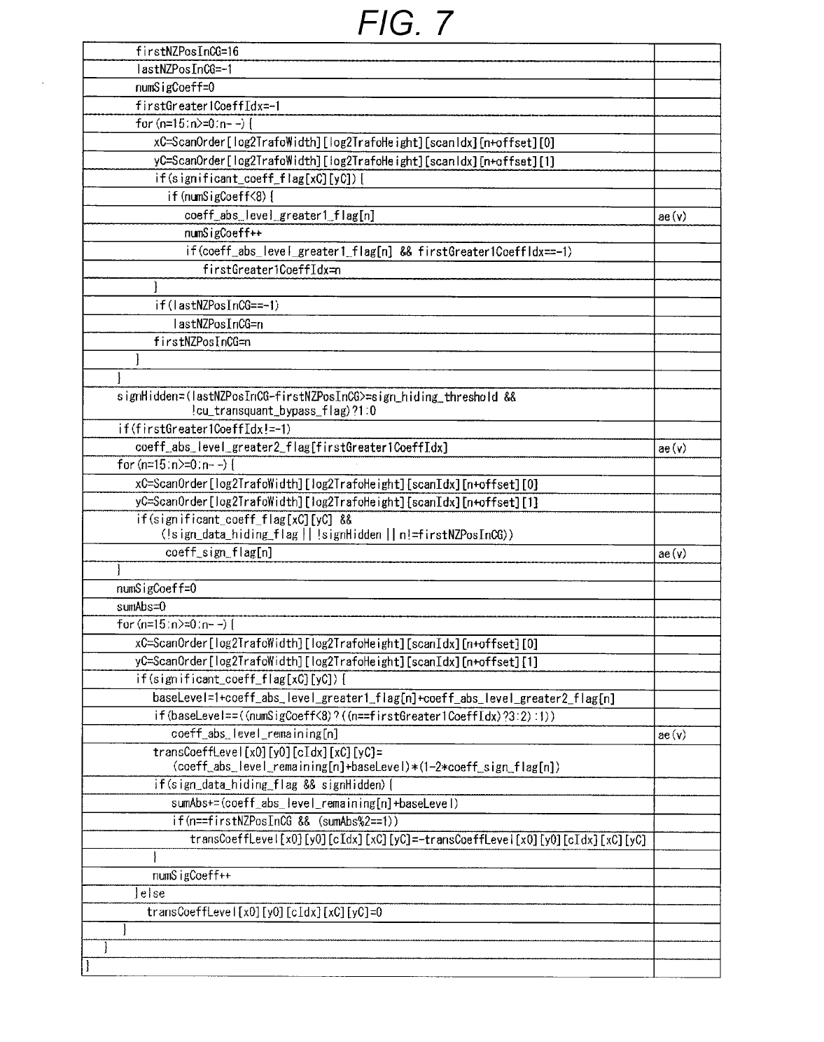

FIGS. 6 and 7 are diagrams illustrating examples of syntax that defines Coef Group that is a unit of the Sign Data Hiding processing in the encoding unit 11.

Coef Group is a scan unit at the time of orthogonal transform.

### (Description of Processing of Encoding Device)

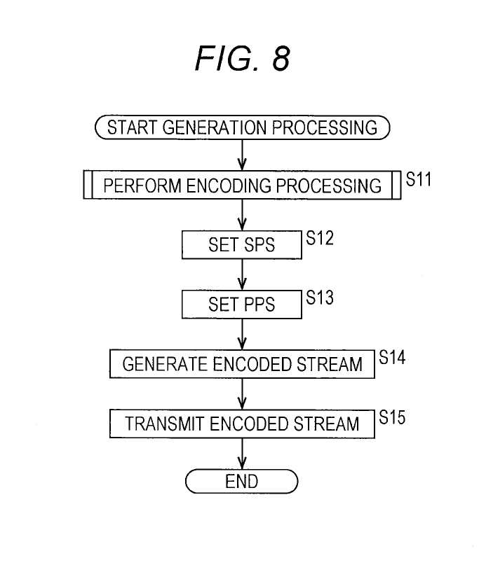

FIG. 8 is a flowchart describing generation processing of the encoding device 10 of FIG. 1.

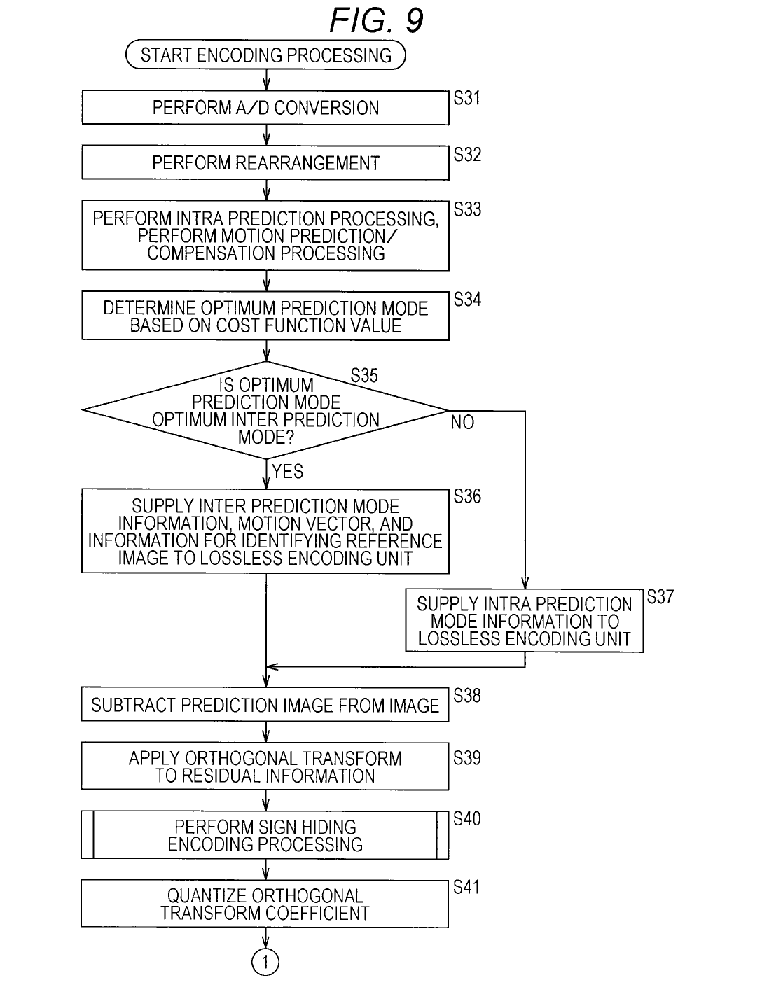

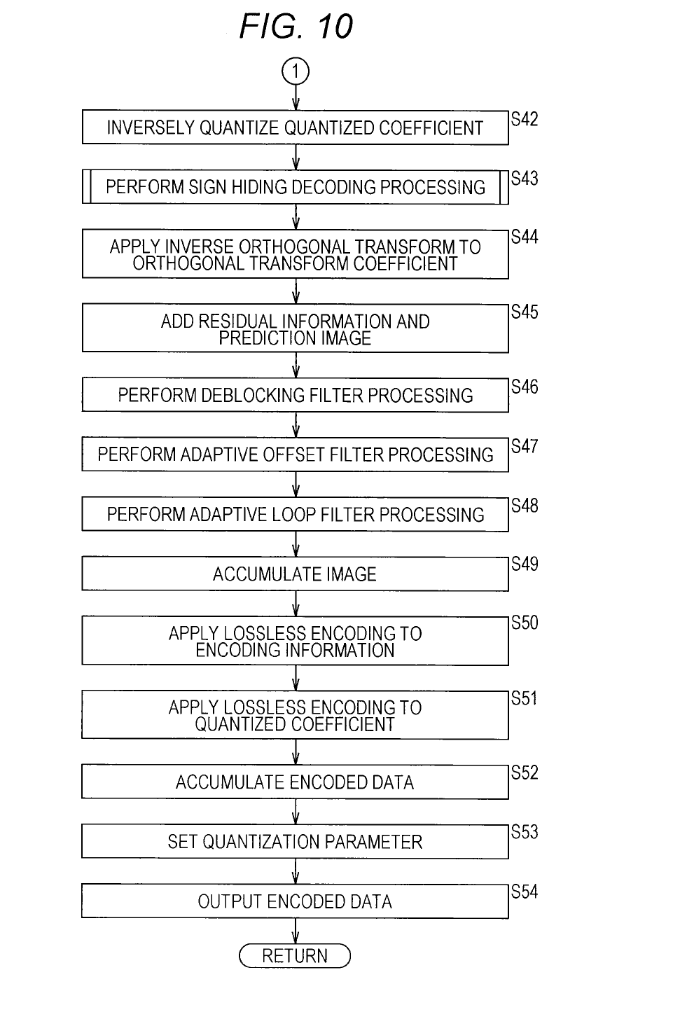

In step S11 of FIG. 8, the encoding unit 11 of the encoding device 10 performs the encoding processing of encoding an image in frame units input as an input signal from an outside, in the HEVC system. Details of the encoding processing will be described with reference to FIGS. 9 and 10 described below.

In step S12, the setting unit 12 sets an SPS including the intra application information and the inter application information. In step S13, the setting unit 12 sets a PPS. In step S14, the setting unit 12 generates an encoded stream from the set SPS and PPS, and the encoded data supplied from the encoding unit 11. The setting unit 12 supplies the encoded stream to the transmission unit 13.

In step S15, the transmission unit 13 transmits the encoded stream supplied from the setting unit 12 to the decoding device described below, and terminates the processing.

FIGS. 9 and 10 are flowcharts describing details of the encoding processing of step S11 of FIG. 8.

In step S31 of FIG. 9, the A/D conversion unit 31 of the encoding unit 11 performs A/D conversion of the image in frame units input as the input signal, and outputs the image to the screen rearrangement buffer 32 and stores the image therein.

In step S32, the screen rearrangement buffer 32 rearranges stored images of frames in the order of display into the order for encoding according to a GOP structure. The screen rearrangement buffer 32 supplies the rearranged images in frame units to the computation unit 33, the intra prediction unit 48, and the motion prediction/compensation unit 49.

In step S33, the intra prediction unit 48 performs the intra prediction processing in all of candidate intra prediction modes. Further, the intra prediction unit 48 calculates a cost function value for all of candidate intra prediction modes based on the image read from the screen rearrangement buffer 32 and a prediction image generated as a result of the intra prediction processing. Then, the intra prediction unit 48 determines an intra prediction mode having the minimum cost function value as an adaptive intra prediction mode. The intra prediction unit 48 supplies a prediction image generated in the adaptive intra prediction mode and the corresponding cost function value to the prediction image selection unit 50.

Further, the motion prediction/compensation unit 49 performs the prediction/compensation processing in all of candidate inter prediction modes. Further, the motion prediction/compensation unit 49 calculates a cost function value for all of candidate inter prediction modes based on the image supplied from the screen rearrangement buffer 32 and the prediction image, and determines an inter prediction mode having the minimum cost function value as an optimum inter measurement mode. Then, the motion prediction/compensation unit 49 supplies the cost function value of the optimum inter prediction mode and the corresponding prediction image to the prediction image selection unit 50.

In step S34, the prediction image selection unit 50 determines either the adaptive intra prediction mode or the optimum inter prediction mode, the mode having the minimum cost function mode, as the optimum prediction mode, based on the cost function values supplied from the intra prediction unit 48 and the motion prediction/compensation unit 49 by the processing of step S33. The prediction image selection unit 50 then supplies the prediction image of the optimum prediction mode to the computation unit 33 and the adding unit 42.

In step S35, the prediction image selection unit 50 determines whether the optimum prediction mode is the optimum inter prediction mode. When the optimum prediction mode has been determined to be the optimum inter prediction mode in step S35, the prediction image selection unit 50 notifies the motion prediction/compensation unit 49 of selection of the prediction image generated in the optimum inter prediction mode.

In step S36, the motion prediction/compensation unit 49 supplies the inter prediction mode information, the corresponding motion vector, and the information for identifying a reference image to the lossless encoding unit 37, and advances the processing to step S38.

Meanwhile, when the optimum prediction mode has been determined not to be the optimum inter prediction mode in step S35, that is, when the optimum prediction mode is the adaptive intra prediction mode, the prediction image selection unit 50 notifies the intra prediction unit 48 of selection of the prediction image generated in the adaptive intra prediction mode. Then, in step S37, the intra prediction unit 48 supplies the intra prediction mode information to the lossless encoding unit 37, and advances the processing to step S38.

In step S38, the computation unit 33 performs encoding by subtracting the prediction image supplied from the prediction image selection unit 50 from the image supplied from the screen rearrangement buffer 32. The computation unit 33 outputs an image obtained as a result of the encoding to the orthogonal transform unit 34 as the residual information.

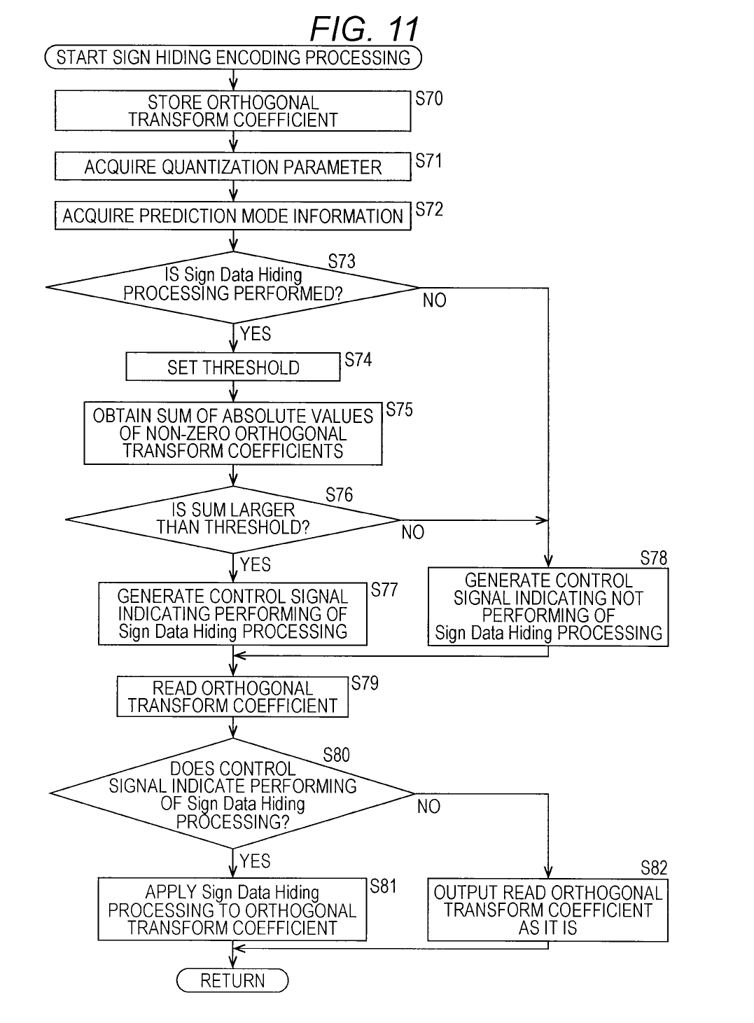

In step S39, the orthogonal transform unit 34 applies orthogonal transform to the residual information from the computation unit 33, and supplies an orthogonal transform coefficient obtained as a result of the orthogonal transform to the sign hiding encoding unit 35. In step S40, the sign hiding encoding unit 35 applies the sign data hiding processing to the orthogonal transform coefficient supplied from the orthogonal transform unit 34. Details of the sign hiding encoding processing will be described with reference to FIG. 11 described below.

In step S41, the quantization unit 36 quantizes the coefficient supplied from the orthogonal transform unit 34 using the quantization parameter supplied from the rate control unit 51. The quantized coefficient is input to the lossless encoding unit 37 and the inverse quantization unit 39. Further, the quantization unit 36 supplies the quantization parameter to the sign hiding encoding unit 35.

In step S42 of FIG. 10, the inverse quantization unit 39 inversely quantizes the quantized coefficient supplied from the quantization unit 36 using the quantization parameter supplied from the rate control unit 51, supplies an orthogonal transform coefficient obtained as a result of the inverse quantization to the inverse orthogonal transform unit 40. The inverse orthogonal transform unit 40 supplies the orthogonal transform coefficient to the sign hiding decoding unit 41.

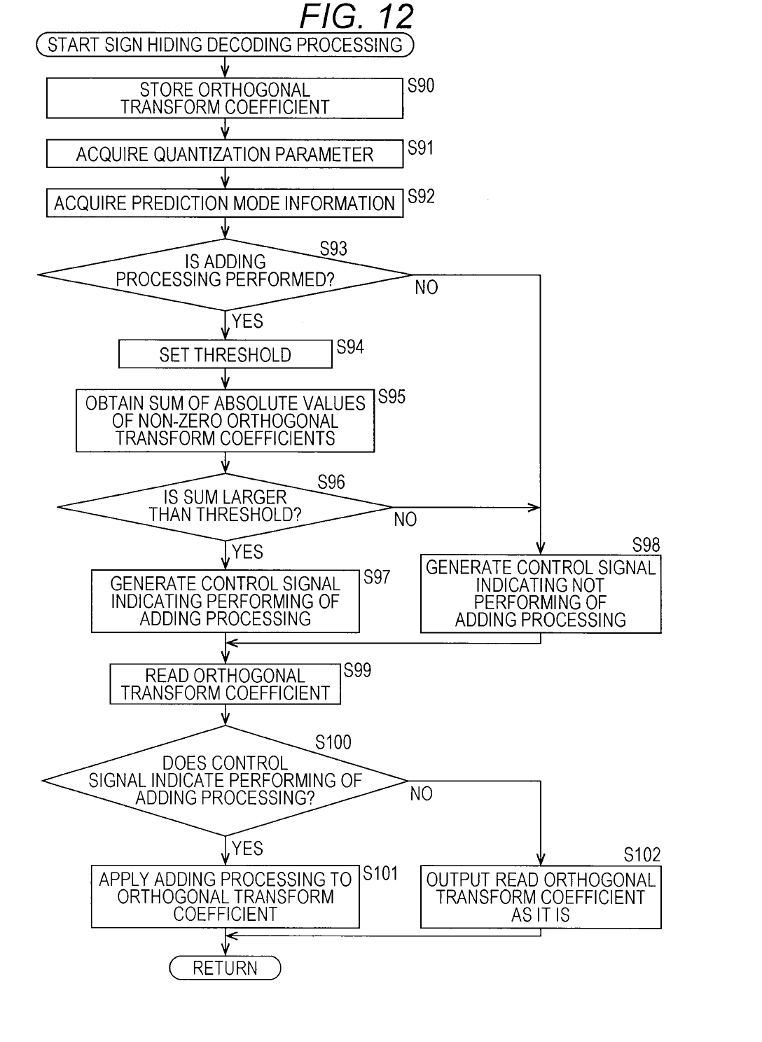

In step S43, the sign hiding decoding unit 41 performs sign hiding decoding processing of applying adding processing to the orthogonal transform coefficient supplied from the inverse quantization unit 39. Details of the sign hiding decoding processing will be described with reference to FIG. 12 described below.

In step S44, the inverse orthogonal transform unit 40 applies inverse orthogonal transform to the orthogonal transform coefficient supplied form the sign hiding decoding unit 41, and supplies residual information obtained as a result of the inverse orthogonal transform to the adding unit 42.

In step S45, the adding unit 42 adds the residual information supplied from the inverse orthogonal transform unit 40 and the prediction image supplied from the prediction image selection unit 50 to obtain a locally decided image. The adding unit 42 supplies the obtained image to the deblock filter 43 and the frame memory 46.

In step S46, the deblock filter 43 applies deblocking filter processing to the locally decoded image supplied from the adding unit 42. The deblock filter 43 supplies an image obtained as a result of the deblocking filter processing to the adaptive offset filter 44.

In step S47, the adaptive offset filter 44 applies adaptive offset filter processing to the image supplied from the deblock filter 43 for each LCU. The adaptive offset filter 44 supplies an image obtained as a result of the adaptive offset filter processing to the adaptive loop filter 45. Further, the adaptive offset filter 44 supplies a storage flag, an index or offset, and type information to the lossless encoding unit 37 as offset filter information, for each LCU.

In step S48, the adaptive loop filter 45 applies adaptive loop filter processing to the image supplied from the adaptive offset filter 44 for each LCU. The adaptive loop filter 45 supplies an image obtained as a result of the adaptive loop filter processing to the frame memory 46. Further, the adaptive loop filter 45 supplies a filter coefficient used in the adaptive loop filter processing to the lossless encoding unit 37.

In step S49, the frame memory 46 accumulates the image supplied from the adaptive loop filter 45 and the image supplied from the adding unit 42. The images accumulated in the frame memory 46 are output to the intra prediction unit 48 or the motion prediction/compensation unit 49 through the switch 47 as reference images.

In step S50, the lossless encoding unit 37 applies lossless encoding to the intra prediction mode information or the inter prediction mode information, the motion vector, the information that identifies a reference image, and the like, the quantization parameter, the offset filter information, and the filter coefficient from the rate control unit 51 as encoding information.

In step S51, the lossless encoding unit 37 inversely encodes the quantized coefficient supplied from the quantization unit 36. The lossless encoding unit 37 then generates encoded data from the encoding information and the coefficients subjected to the lossless encoding in the processing of step S50.

In step S52, the accumulation buffer 38 temporarily stores the encoded data supplied from the lossless encoding unit 37.

In step S53, the rate control unit 51 determines a quantization parameter to be used in the quantization unit 36 such that overflow or underflow does not occur, based on the encoded data accumulated in the accumulation buffer 38. The rate control unit 51 supplies the determined quantization parameter to the quantization unit 36, the lossless encoding unit 37, and the inverse quantization unit 39.

In step S54, the accumulation buffer 38 outputs the stored encoded data to the setting unit 12 of FIG. 1.

Note that, in the encoding processing of FIGS. 9 and 10, the intra prediction processing and the motion prediction/compensation processing are always performed for simplification of the description. However, practically, there is a case where only one of them is performed according to a picture type or the like.

FIG. 11 is a flowchart describing details of the sign hiding encoding processing of step S40 of FIG. 9.

In step S70 of FIG. 11, the orthogonal transform coefficient buffer 71 (FIG. 3) of the sign hiding encoding unit 35 stores the orthogonal transform coefficient supplied from the orthogonal transform unit 34. In step S71, the threshold setting unit 73 acquires the quantization parameter from the quantization unit 36 of FIG. 2. In step S72, the threshold setting unit 73 acquires the prediction mode information from the lossless encoding unit 37 of FIG. 2.

In step S73, the threshold setting unit 73 determines whether performing the sign data hiding processing based on the intra application information and the inter application information generated in advance according to a user input or the like, and the prediction mode information supplied from the lossless encoding unit 37.

To be specific, when the prediction mode information indicates the intra prediction mode, and the intra application information indicates performing of the sign data hiding processing, the threshold setting unit 73 determines performing of the sign data hiding processing. Further, when the prediction mode information indicates the inter prediction mode, and the inter application information indicates performing of the sign data hiding processing, the threshold setting unit 73 determines performing of the sign data hiding processing.

Meanwhile, when the prediction mode information indicates the intra prediction mode, and the intra application information indicates not performing of the sign data hiding processing, the threshold setting unit 73 determines not performing of the sign data hiding processing. Further, when the prediction mode information indicates the inter prediction mode, and the inter application information indicates not performing of the sign data hiding processing, the threshold setting unit 73 determines not performing of the sign data hiding processing.

In step S74, when the sign data hiding processing has been determined to be performed in step S73, the threshold setting unit 73 sets a threshold such that the threshold becomes larger as the quantization parameter is larger based on the quantization parameter. The threshold setting unit 73 supplies the set threshold to the threshold determination unit 74.

In step S75, the absolute value sum calculation unit 72 reads non-zero orthogonal transform coefficients from the orthogonal transform coefficient buffer 71, obtains a sum of absolute values of the non-zero orthogonal transform coefficients, and supplies the sum to the threshold determination unit 74 and the coefficient operation unit 75.

In step S76, the threshold determination unit 74 determines whether the sum supplied from the absolute value sum calculation unit 72 is larger than the threshold. In step S77, when the sum has been determined to be larger than the threshold in step S76, the threshold determination unit 74 generates a control signal that indicates performing of the sign data hiding processing, and supplies the control signal to the coefficient operation unit 75. Then, the processing proceeds to step S79.

Meanwhile, when the sign data hiding processing has been determined not to be performed in step S73, or when the sum has been determined to be the threshold or less in step S76, the processing proceeds to step S78. In step S78, the threshold determination unit 74 generates a control signal that indicates not performing of the sign data hiding processing, and supplies the control signal to the coefficient operation unit 75. The processing proceeds to step S79.

In step S79, the coefficient operation unit 75 reads the orthogonal transfer coefficient from the orthogonal transform coefficient buffer 71. In step S80, the coefficient operation unit 75 determines whether the control signal supplied from the threshold determination unit 74 indicates performing of the sign data hiding processing.

In step S80, when the control signal has been determined to indicate performing of the sign data hiding processing, in step S81, the coefficient operation unit 75 applies the sign data hiding Processing to the read orthogonal transform coefficient. Then, the coefficient operation unit 75 supplies the orthogonal transform coefficient subjected to the sign data hiding processing to the orthogonal transform unit 34 of FIG. 2, and returns the processing to step S40 of FIG. 9. Then, the processing proceeds to step S41.

Meanwhile, when the control signal has been determined to indicate not performing of the sign data hiding processing in step S80, in step S82, the coefficient operation unit 75 outputs the read orthogonal transform coefficient to the orthogonal transform unit 34 as it is, and returns the processing to step S40 of FIG. 9. Then, the processing proceeds to step S41.

FIG. 12 is a flowchart describing details of the sign hiding decoding processing of step S43 of FIG. 10.

In step S90 of FIG. 12, the orthogonal transform coefficient buffer 91 (FIG. 4) of the sign hiding decoding unit 41 stores the orthogonal transform coefficient supplied from the inverse orthogonal transform unit 40 of FIG. 2.

In step S91, the threshold setting unit 93 acquires the quantization parameter from the lossless encoding unit 37. In step S92, the threshold setting unit 93 acquires the prediction mode information from the lossless encoding unit 37.

In step S93, the threshold setting unit 93 determines whether performing adding processing based on the intra application information and the inter application information generated in advance according to a user input or the like, and the prediction mode information supplied from the lossless encoding unit 37, similarly to the threshold setting unit 73.

When the adding processing has been determined to be performed in step S93, in step S94, the threshold setting unit 93 sets a threshold based on the quantization parameter, similarly to the threshold setting unit 73, and supplies the threshold to the threshold determination unit 94.

In step S95, the absolute value sum calculation unit 72 reads non-zero orthogonal transform coefficients from the orthogonal transform coefficient buffer 91, obtains a sum of absolute values of the non-zero orthogonal transform coefficients, and supplies the sum to the threshold determination unit 74 and the coefficient operation unit 75.

In step S96, the threshold determination unit 94 determines whether the sum supplied from the absolute value sum calculation unit 92 is larger than the threshold. When the sum has been determined to be larger than the threshold in step S96, in step S97, the threshold determination unit 94 generates a control signal that indicates performing of the adding processing, and supplies the control signal to the sign decoding unit 95. Then, the processing proceeds to step S99.

Meanwhile, when the adding processing has been determined not to be performed in step S93, or the sum has been determined to be the threshold or less in step S96, the processing proceeds to step S98. In step S98, the threshold determination unit 94 generates a control signal that indicates not performing of the adding processing, and supplies the control signal to the sign decoding unit 95. Then, the processing proceeds to step S99.

In step S99, the sign decoding unit 95 reads the orthogonal transform coefficient from the orthogonal transform coefficient buffer 91. In step S100, the sign decoding unit 95 determines whether the control signal supplied form the threshold determination unit 94 indicates performing of the adding processing.

In step S100, when the control signal has been determined to indicate performing of the adding processing, in step S101, the sign decoding unit 95 applies the adding processing to the read orthogonal transform coefficient. Then, the sign decoding unit 95 supplies the orthogonal trans form coefficient subjected to the adding processing to the inverse orthogonal transform unit 40 of FIG. 2, and returns the processing to step S43 of FIG. 10. Then, the processing proceeds to step S44.

Meanwhile, when the control signal has been determined to indicate not performing of the adding processing in step S100, in step S102, the sign decoding unit 95 outputs the read orthogonal transform coefficient to the inverse orthogonal transform unit 40 as it is, and returns the processing to step S43 of FIG. 10. Then, the processing proceeds to step S44.

As described above, the encoding device 10 applies the sign data hiding processing to the orthogonal transform coefficients based on the sum of the absolute values of the non-zero orthogonal transform coefficients of the orthogonal transform coefficients of the residual information. Therefore, the encoding device 10 can appropriately perform the sign data hiding processing.

That is, influence of a quantization error due to application of the sign data hiding processing on the image quality differs depending on the size of the non-orthogonal transform coefficient. To be specific, when the non-zero orthogonal transform coefficient is 30, for example, the sign data hiding processing is 31 by the sign data hiding processing, and when the non-zero orthogonal transform coefficient is 1, the sign data hiding processing is 2 by the sign data hiding processing, and the latter case has substantial influence on the image quality.

Therefore, the encoding device 10 performs the sign data hiding processing based on the sum of the absolute values of the non-zero orthogonal transform coefficients, thereby not to perform the sign data hiding processing when there is substantial influence. Therefore, the encoding device 10 can appropriately perform the sign data hiding processing. As a result, the encoding device 10 can improve the encoding efficiency while suppressing deterioration of the image quality.

Further, the sum of the absolute values of the non-zero orthogonal transform coefficients is used for the sign data hiding processing. Therefore, the encoding device 10 does not need newly performing computation for determining whether performing the sign data hiding processing.

Further, the encoding device 10 sets the threshold of the sum of the absolute values of the non-zero orthogonal transform coefficients based on the quantization parameter. Accordingly, when the quantization parameter is large, that is, when there is substantial influence of the quantization error on the image quality, the encoding device 10 suppresses the sign data hiding processing by making the threshold large.

Further, the encoding device 10 sets the intra application information and the inter application information, and thus can more appropriately perform the sign data hiding processing. That is, when the intra prediction is performed, typically, the image quality of the prediction image is lower than a case where the inter prediction is performed. Therefore, the residual information, that is, the orthogonal transform coefficient is more important. Therefore, the encoding device 10 performs the sign data hiding processing only when the optimum prediction mode is the inter prediction mode where the influence of the quantization error due to application of the sign data hiding processing on the image quality is relatively low, thereby more appropriately performing the sign data hiding processing.

### (Configuration Example of Embodiment of Decoding Device)

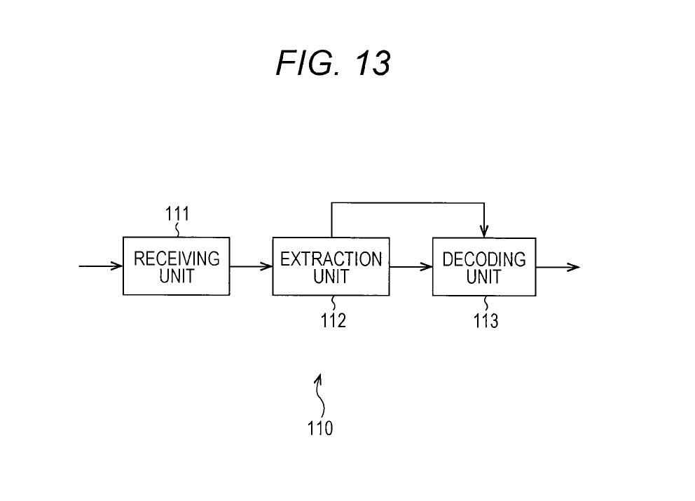

FIG. 13 is a block diagram illustrating a configuration example of an embodiment of a decoding device to which the present technology is applied, which decodes an encoded stream transmitted from the encoding device 10 of FIG. 1.

A decoding device 110 of FIG. 13 is configured from a receiving unit 111, an extraction unit 112, and a decoding unit 113.

The receiving unit 111 of the decoding device 110 receives an encoded stream transmitted from the encoding device 10 of FIG. 1, and supplies the encoded stream to the extraction unit 112. The extraction unit 112 extracts an SPS, a PPS, encoded data, and the like from the encoded stream supplied from the receiving unit 111. The extraction unit 112 supplies the encoded data to the decoding unit 113. Further, the extraction unit 112 supplies the SPS, the PPS, and the like to the decoding unit 113, as needed.

The decoding unit 113 refers to the SPS, the PPS, and the like supplied from the extraction unit 112, as needed, and decodes the encoded data supplied from the extraction unit 112 in the HEVC system. The decoding unit 113 outputs an image obtained as a result of the decoding as an output signal.

### (Configuration Example of Decoding Unit)

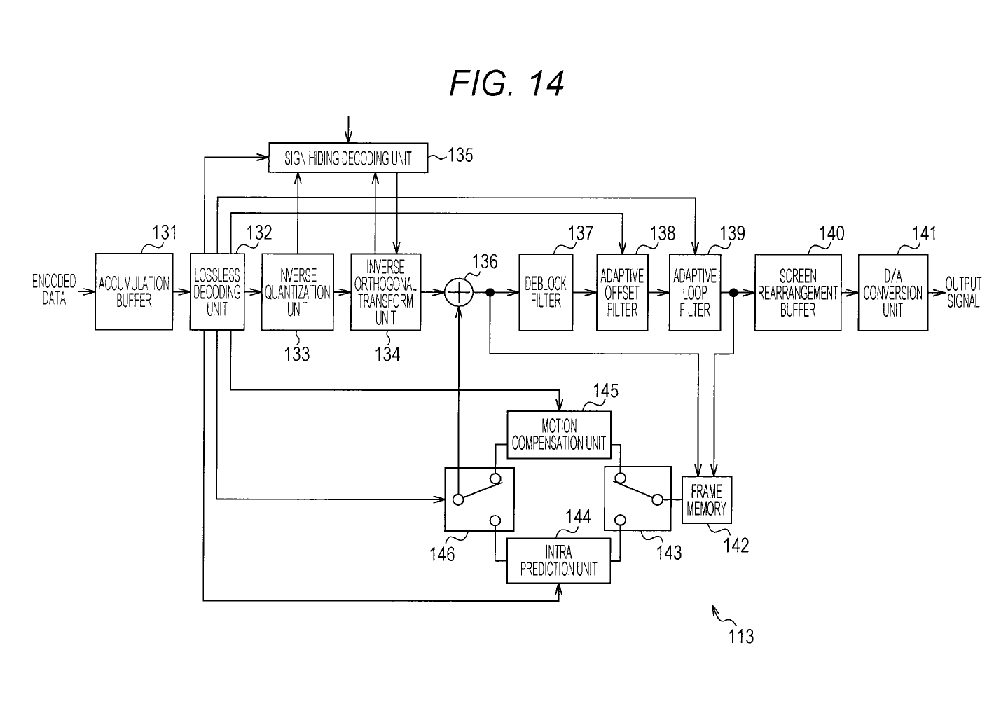

FIG. 14 is a block diagram illustrating a configuration example of the decoding unit 113 of FIG. 13.

The decoding unit 113 of FIG. 14 is configured from an accumulation buffer 131, a lossless decoding unit 132, an inverse quantization unit 133, an inverse orthogonal transform unit 134, a sign hiding decoding unit 135, an adding unit 136, a deblock filter 137, an adaptive offset filter 138, an adaptive loop filter 139, a screen rearrangement buffer 140, a D/A conversion unit 141, a frame memory 142, a switch 143, an intra prediction unit 144, a motion compensation unit 145, and a switch 146.

The accumulation buffer 131 of the decoding unit 113 receives the encoded data from the extraction unit 112 of FIG. 13, and accumulates the encoded data. The accumulation buffer 131 supplies the accumulated encoded data to the lossless decoding unit 132.

The lossless decoding unit 132 obtains a quantized coefficient and quantized encoding information by applying lossless decoding such as variable length decoding or arithmetic decoding to the encoded data from the accumulation buffer 131. The lossless decoding unit 132 supplies the quantized coefficient to the inverse quantization unit 133. Further, the lossless decoding unit 132 supplies intra prediction mode information and the like as the encoding information to the intra prediction unit 144, and supplies a motion vector, information for identifying a reference image, inter prediction mode information, and the like to the motion compensation unit 145.

Further, the lossless decoding unit 132 supplies intra prediction mode information or the inter prediction mode information as the encoding information to the switch 146. The lossless decoding unit 132 supplies offset filter information as the encoding information to the adaptive offset filter 138, and supplies a filter coefficient to the adaptive loop filter 139. Further, the lossless decoding unit 132 supplies a quantization parameter and the intra prediction mode information or the inter prediction mode information as the encoding information to the sign hiding decoding unit 135.

The inverse quantization unit 133, the inverse orthogonal transform unit 134, the sign hiding decoding unit 135, the adding unit 136, the deblock filter 137, the adaptive offset filter 138, the adaptive loop filter 139, the frame memory 142, the switch 143, the intra prediction unit 144, and the motion compensation unit 145 perform similar processing to the inverse quantization unit 39, the inverse orthogonal transform unit 40, the sign hiding decoding unit 41, the adding unit 42, the deblock filter 43, the adaptive offset filter 44, the adaptive loop filter 45, the frame memory 46, the switch 47, the intra prediction unit 48, and the motion prediction/compensation unit 49 of FIG. 2, and an image is decoded, accordingly.

To be specific, the inverse quantization unit 133 inversely quantizes the quantized coefficient from the lossless decoding unit 132, and supplies an orthogonal transform coefficient obtained as a result of the inverse quantization to the inverse orthogonal transform unit 134.

The inverse orthogonal transform unit 134 supplies the orthogonal transform coefficient from the inverse quantization unit 133 to the sign hiding decoding unit 135, and applies inverse orthogonal transform to the orthogonal transform coefficient supplied from the sign hiding decoding unit 135. The inverse orthogonal transform unit 134 supplies residual information obtained as a result of the inverse orthogonal transform to the adding unit 136.

The sign hiding decoding unit 135 is configured similarly to the sign hiding decoding unit 41 of FIG. 4. The sign hiding decoding unit 135 applies adding processing to the orthogonal transform coefficient based on the intra application information and the inter application information included in the SPS from the extraction unit 112, the quantization parameter and the prediction mode information from the lossless decoding unit 132, and the orthogonal transform coefficient from the inverse orthogonal transform unit 134.

Here, the intra application information is information that indicates whether performing the sign data hiding processing when the optimum prediction mode is the intra prediction mode, and thus is used as information that indicates whether performing adding processing corresponding to the sign data hiding processing when the optimum prediction mode is the intra prediction mode. Similarly, the inter application information is used as information that indicates whether performing adding processing corresponding to the sign data hiding processing when the optimum prediction mode is the inter prediction mode. The sign hiding decoding unit 135 supplies the orthogonal transform coefficient subjected to the adding processing to the inverse orthogonal transform unit 134.

The adding unit 136 performs decoding by adding the residual information as an image to be decoded supplied from the inverse orthogonal transform unit 134, and a prediction image supplied from the switch 146. The adding unit 136 supplies an image obtained as a result of the decoding to the deblock filter 137 and the frame memory 142. Note that, when the prediction image is not supplied from the switch 146, the adding unit 136 supplies the image as the residual information supplied from the inverse orthogonal transform unit 134 to the deblock filter 137 as the image obtained as a result of the decoding, and supplies the image to the frame memory 142 and stores the image therein.

The deblock filter 137 applies adaptive deblock filter processing to the image supplied from the adding unit 136, and supplies an image obtained as a result of the adaptive deblock filter processing to the adaptive offset filter 138.

The adaptive offset filter 138 includes a buffer that stores offsets supplied from the lossless decoding unit 132 in turn. Further, the adaptive offset filter 138 applies adaptive offset filter processing to the image subjected to the adaptive deblock filter processing by the deblock filter 137 for each LCU based on offset filter information supplied from the lossless decoding unit 132.

To be specific, when a storage flag included in the offset filter information is 0, the adaptive offset filter 138 applies a type of adaptive offset filter processing, the type being indicated by type information, to the image subjected to the deblock filter processing in LCU units using the offset included in the offset filter information.

Meanwhile, when the storage flag included in the offset filter information is 1, the adaptive offset filter 138 reads an offset stored in a position indicated by the index included in the offset filter information, for the image subjected to the deblock filter processing in LCU units. Then, the adaptive offset filter 138 performs a type of adaptive offset filter processing, the type being indicated by the type information, using the read offset. The adaptive offset filter 138 supplies an image subjected to the adaptive offset filter processing to the adaptive loop filter 139.

The adaptive loop filter 139 applies adaptive loop filter processing to the image supplied from the adaptive offset filter 138 using the filter coefficient supplied from the lossless decoding unit 132, for each LCU. The adaptive loop filter 139 supplies an image obtained as a result of the adaptive loop filter processing to the frame memory 142 and the screen rearrangement buffer 140.

The screen rearrangement buffer 140 stores the image supplied from the adaptive loop filter 139 in frame units. The screen rearrangement buffer 140 rearranges stored images in frame units in an order for encoding into an order of display, and supplies the images to the D/A conversion unit 141.

The D/A conversion unit 141 applies D/A conversion to the images in frame units supplied from the screen rearrangement buffer 140, and outputs the images as output signals. The frame memory 142 accumulates the image supplied from the adaptive loop filter 139 and the image supplied from the adding unit 136. The images accumulated in the frame memory 142 are read as reference images, and are supplied to the motion compensation unit 145 or the intra prediction unit 144 through the switch 143.

The intra prediction unit 144 performs intra prediction processing of the intra prediction mode indicated by the intra prediction mode information supplied from the lossless decoding unit 132 using the reference image read from the frame memory 142 through the switch 143. The intra prediction unit 144 supplies a prediction image obtained as a result of the intra prediction processing to the switch 146.

The motion compensation unit 145 reads the reference image from the frame memory 142 through the switch 143 based on the information for identifying a reference image supplied from the lossless decoding unit 132. The motion compensation unit 145 performs motion compensation processing of the optimum inter prediction mode indicated by the inter prediction mode information using the motion vector and the reference image. The motion compensation unit 145 supplies a prediction image obtained as a result of the motion compensation processing to the switch 146.

When the intra prediction mode information has been supplied from the lossless decoding unit 132, the switch 146 supplies the prediction image supplied from the intra prediction unit 144 to the adding unit 136. Meanwhile, when the inter prediction mode information has been supplied from the lossless decoding unit 132, the switch 146 supplies the prediction image supplied from the motion compensation unit 145 to the adding unit 136.

### (Description of Processing of Decoding Device)

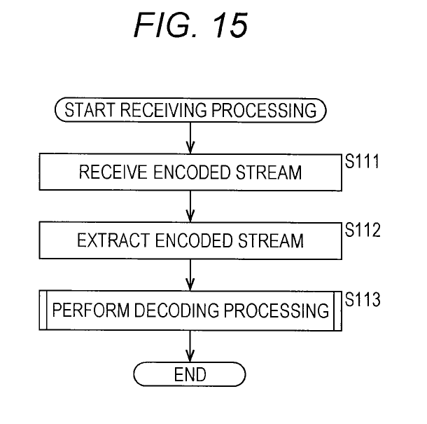

FIG. 15 is a flowchart describing receiving processing by the decoding device 110 of FIG. 13.

In step S111 of FIG. 15, the receiving unit 111 of the decoding device 110 receives an encoded stream transmitted from the encoding device 10 of FIG. 1, and supplies the encoded stream to the extraction unit 112.

In step S112, the extraction unit 112 extracts an SPS, a PPS, encoded data, and the like from the encoded stream supplied from the receiving unit 111. The extraction unit 112 supplies the encoded data to the decoding unit 113. Further, the extraction unit 112 supplies the SPS, the PPS, and the like to the decoding unit 113, as needed.

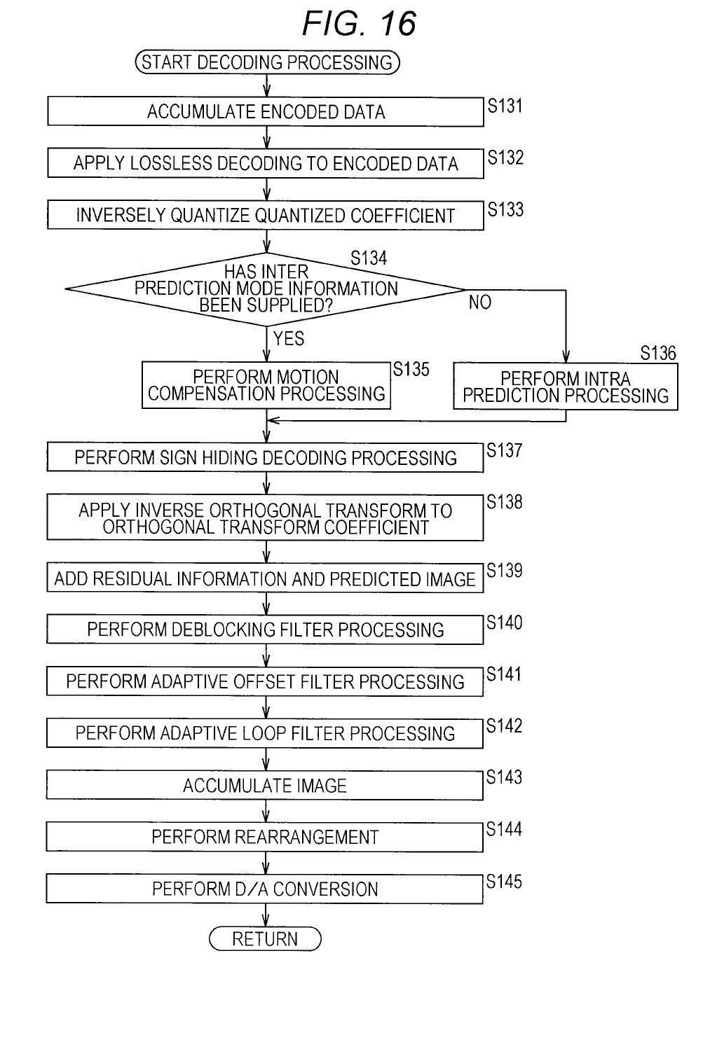

In step S113, the decoding unit 113 refers to the SPS, the PPS, and the like supplied from the extraction unit 112, as needed, and performs decoding processing of decoding the encoded data supplied from the extraction unit 112, in the HEVC system. Details of the decoding processing will be described with reference to FIG. 16 described below. The processing is terminated.

FIG. 16 is a flowchart describing details of the decoding processing of step S113 of FIG. 15.

In step S131 of FIG. 16, the accumulation buffer 131 of the decoding unit 113 receives the encoded data in frame units from the extraction unit 112 of FIG. 13, and accumulates the encoded data therein. The accumulation buffer 131 supplies the accumulated encoded data to the lossless decoding unit 132.

In step S132, the lossless decoding unit 132 performs lossless decoding of the encoded data from the accumulation buffer 131 to obtain a quantized coefficient and encoding information. The lossless decoding unit 132 supplies the quantized coefficient to the inverse quantization unit 133. Further, the lossless decoding unit 132 supplies intra prediction mode information as the encoding information and the like to the intra prediction unit 144, and supplies a motion vector, inter prediction mode information, information for identifying a reference image, and the like to the motion compensation unit 145.

Further, the lossless decoding unit 132 supplies the intra prediction mode information or the inter prediction mode information as the encoding information to the switch 146. The lossless decoding unit 132 supplies offset filter information as the encoding information to the adaptive offset filter 138, and supplies a filter coefficient to the adaptive loop filter 139. Further, the lossless decoding unit 132 supplies a quantization parameter, the intra prediction mode information or the inter prediction mode information as the encoding information to the sign hiding decoding unit 135.

In step S133, the inverse quantization unit 133 inversely quantizes the quantized coefficient from the lossless decoding unit 132, and an orthogonal transform coefficient obtained as a result of the inverse quantization to the inverse orthogonal transform unit 134. The inverse orthogonal transform unit 134 supplies the orthogonal transform coefficient supplied from the inverse quantization unit 133 to the sign hiding decoding unit 135.

In step S134, the motion compensation unit 145 determines whether the inter prediction mode information has been supplied from the lossless decoding unit 132. When it has been determined in step S134 that the inter prediction mode information has been supplied, the processing proceeds to step S135.

In step S135, the motion compensation unit 145 reads a reference image based on the information for identifying a reference image supplied from the lossless decoding unit 132, and performs motion compensation processing of the optimum inter prediction mode indicated by the inter prediction mode information using a motion vector and the reference image. The motion compensation unit 145 supplies a prediction image generated as a result of the motion compensation processing to the adding unit 136 through the switch 146, and advances the processing to step S137.

Meanwhile, when it has been determined in step S134 that the inter prediction mode information has not been supplied, that is, when the intra prediction mode information has been supplied to the intra prediction unit 144, the processing proceeds to step S136.

In step S136, the intra prediction unit 144 performs intra prediction processing of the intra prediction mode indicated by the intra prediction mode information using the reference image read from the frame memory 142 through the switch 143. The intra prediction unit 144 supplies a prediction image generated as a result of the intra prediction processing to the adding unit 136 through the switch 146, and advances the processing to step S137.

In step S137, the sign hiding decoding unit 135 applies sign hiding decoding processing to the orthogonal transform coefficient supplied from the inverse orthogonal transform unit 134. This sign hiding decoding processing is similar to the sign hiding decoding processing of FIG. 12 except that a point in which the intra application information and the inter application information are included in the SPS from the extraction unit 112, and a point in which the quantization parameter and the prediction mode information are acquired from the lossless decoding unit 132. The sign hiding decoding unit 135 supplies the orthogonal transform coefficient subjected to the adding processing to the inverse orthogonal transform unit 134.

In step S138, the inverse orthogonal transform unit 134 applies inverse orthogonal transform to the orthogonal transform coefficient from the sign hiding decoding unit 135, and supplies residual information obtained as a result of the inverse orthogonal transform to the adding unit 136.

In step S139, the adding unit 136 adds the residual information supplied from the inverse orthogonal transform unit 134, and the prediction image supplied from the switch 146. The adding unit 136 supplies an image obtained as a result of the adding to the deblock filter 137 and the frame memory 142.

In step S140, the deblock filter 137 applies deblocking filter processing to the image supplied from the adding unit 136 to remove block distortion. The deblock filter 137 supplies an image obtained as a result of the deblocking filter processing to the adaptive offset filter 138.

In step S141, the adaptive offset filter 138 applies adaptive offset filter processing to the image subjected to the deblock filter processing by the deblock filter 137, based on the offset filter information supplied from the lossless decoding unit 132, for each LCU. The adaptive offset filter 138 supplies an image subjected to the adaptive offset filter processing to the adaptive loop filter 139.

In step S142, the adaptive loop filter 139 applies adaptive loop filter processing to the image supplied from the adaptive offset filter 138 using the filter coefficient supplied from the lossless decoding unit 132, for each LCU. The adaptive loop filter 139 supplies an image obtained as a result of the adaptive loop filter processing to the frame memory 142 and the screen rearrangement buffer 140.

In step S143, the frame memory 142 accumulates the image supplied from the adding unit 136 and the image supplied from the adaptive loop filter 139. The images accumulated in the frame memory 142 are supplied to the motion compensation unit 145 or the intra prediction unit 144 through the switch 143 as reference images.

In step S144, the screen rearrangement buffer 140 stores the image supplied from the adaptive loop filter 139 in frame units, rearranges stored images in frame units in an order for encoding into an original order for display, and supplies the images to the D/A conversion unit 141.

In step S145, the D/A conversion unit 141 applies D/A conversion to the image supplied from the screen rearrangement buffer 140, and outputs the image as an output signal. The processing is returned to step S113 of FIG. 15, and is terminated.

As described above, the decoding device 110 applies the adding processing to the orthogonal transform coefficients based on the sum of the absolute values of the non-zero orthogonal transform coefficients of the orthogonal transform coefficients of the residual information. Therefore, the sign of the head non-zero orthogonal transform coefficient, which has been deleted by the sign data hiding processing appropriately performed in the encoding device 10 can be restored. As a result, the encoded stream subjected to appropriate sign data hiding processing can be decoded.

Further, the decoding device 110 sets the threshold of the sum of the absolute values of the non-zero orthogonal transform coefficients, based on the quantization parameter of the time of encoding included in the encoding information, similarly to the encoding device 10. Accordingly, the decoding device 110 can restore the sign of the head non-zero orthogonal transform coefficient, the sign having been deleted in the sign data hiding processing appropriately performed in the encoding device 10 using the threshold set based on the quantization parameter.

Further, the decoding device 110 performs the adding processing based on the intra application information and the inter application information included in the SPS. Therefore, the decoding device 110 can restore the sign of the head non-zero orthogonal transform coefficient, the sign having been deleted in the sign data hiding processing appropriately performed in the encoding device 10 based on the intra application information and the inter application information.

### (Application to Multi-View Image Encoding/Multi-View Image Decoding)

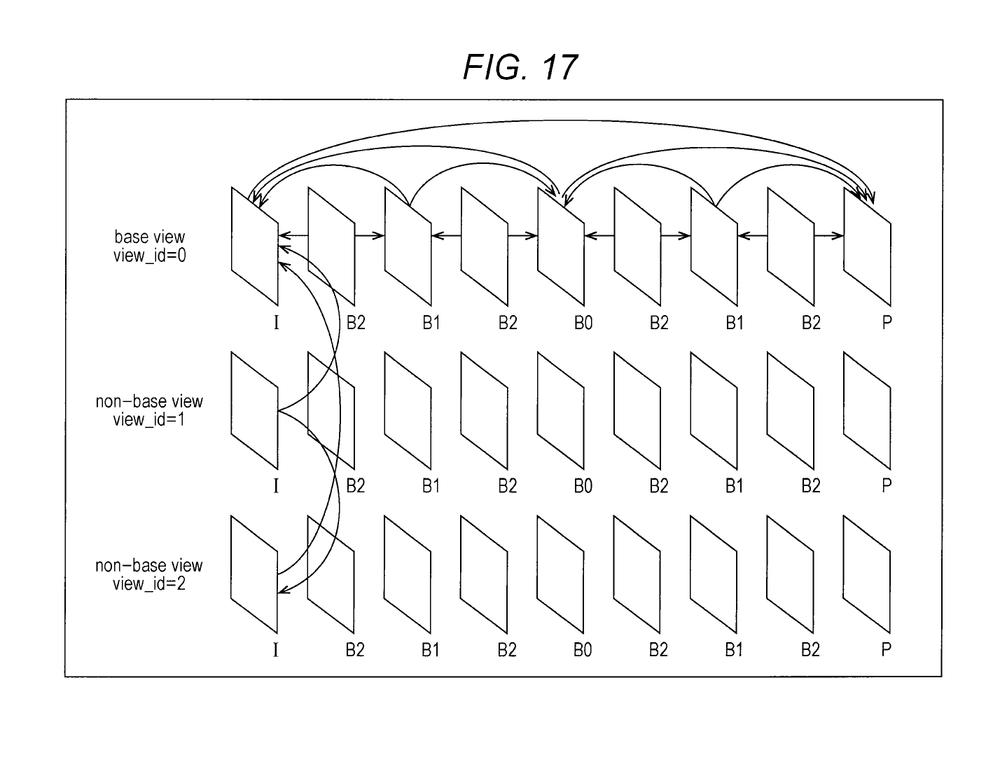

The above-described series of processing can be applied to multi-view image encoding/multi-view image decoding. FIG. 17 illustrates an example of a multi-view image encoding system.

As illustrated in FIG. 17, a multi-view image includes a plurality of views of images, and a predetermined one view of the plurality of views is specified as a base view image. Other view images than the base view image are treated as non-base view images.

When the multi-view image encoding like FIG. 17 is performed, each view image is encoded/decoded. The method of the above-described embodiment may be applied to the encoding/decoding of the each view. Accordingly, the sign data hiding processing can be appropriately performed.

Further, in each view (the same view), a difference between quantization parameters can be obtained:

### (1) Base-View:

(1-1) dQP(baseview)=Current_CU_QP(base view)−LCU_QP(base view)
(1-2) dQP(base view)=Current_CU_QP(base view)−Previsous_CU_QP(base view)
(1-3) dQP(base view)=Current_CU_QP(base view)−Slice_QP(base view)
(2) Non-Base-View: (2-1) dQP(non-base view)=Current_CU_QP(non-base view)−LCU_QP(non-base view)
(2-2) dQP(non-base view)=CurrentQP(non-base view)−PrevisousQP(non-base view)
(2-3) dQP(non-base view)=Current_CU_QP(non-base view)−Slice_QP(non-base view)

When the multi-view image encoding is performed, a difference between quantization parameters in views (different views) can be obtained:

### (3) Base-View/Non-Base View:

(3-1) dQP(inter-view)=Slice_QP(base view)−Slice_QP(non-base view)
(3-2) dQP(inter-view)=LCU_QP(base view)−LCU_QP(non-base view)

### (4) Non-Base View/Non-Base View:

(4-1) dQP(inter-view)=Slice_QP(non-base view i)−Slice_QP(non-base view j)
(4-2) dQP(inter-view)=LCU_QP(non-base view i)−LCU_QP(non-base view j)

In this case, the above (1) to (4) can be combined. For example, in a non-base view, a technique of obtaining a difference of quantization parameters between the base view and the non-base view in a slice level (3-1 and 2-3 are combined), and a technique of obtaining a difference of quantization parameters between the base view and the non-base view in a LCU level (3-2 and 2-1 are combined) can be considered. As described above, by repetitively applying of a difference, the encoding efficiency can be improved even if multi-view encoding is performed.

Similarly to the above-described techniques, a flag that identifies whether there is a dQP in which a value is not 0 can be set to each dQP.

### (Configuration Example of Multi-view Image Encoding Device)

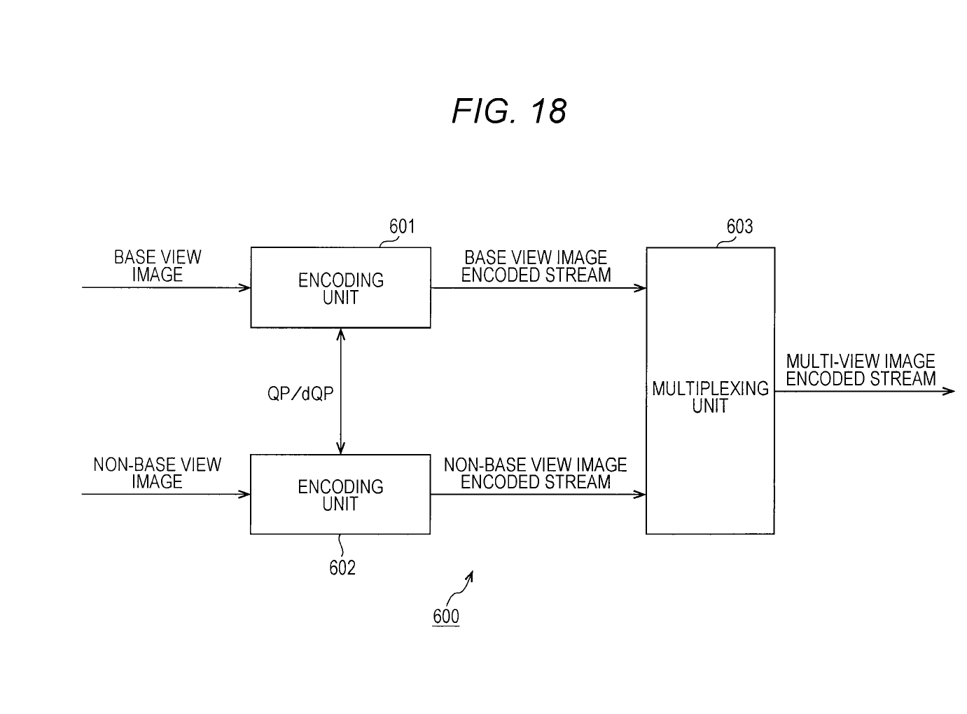

FIG. 18 is a diagram illustrating a multi-view image encoding device that encodes the multi-view image. As illustrated in FIG. 18, a multi-view image encoding device 600 includes an encoding unit 601, an encoding unit 602, and a multiplexing unit 603.

The encoding unit 601 encodes the base view image to generate a base view image encoded stream. The encoding unit 602 encodes the non-base view image to generate a non-base view image encoded stream. The multiplexing unit 603 multiplexes the base view image encoded stream generated in the encoding unit 601 and the non-view image encoded stream generated in the encoding unit 602 to generate a multi-view image encoded stream.

The encoding device 10 (FIG. 1) can be applied to the encoding unit 601 and the encoding unit 602 of the multi-view image encoding device 600. In this case, the multi-view image encoding device 600 sets and transmits a difference value between a quantization parameter set by the encoding unit 601 and a quantization parameter set by the encoding unit 602.

### (Configuration Example of Multi-View Image Decoding Device)

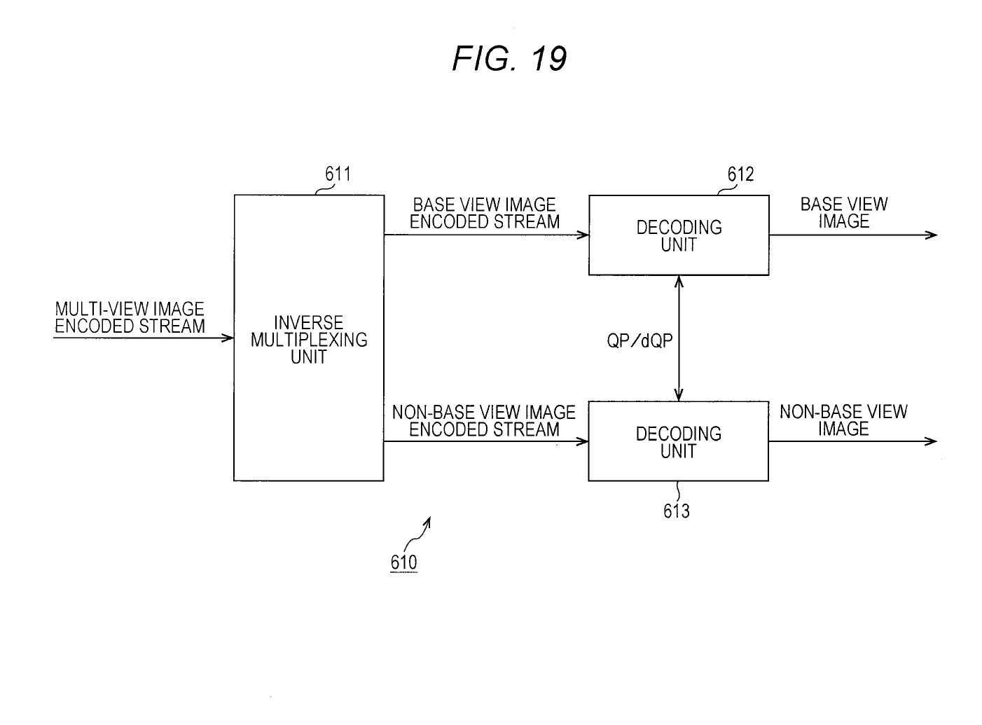

FIG. 19 is a diagram illustrating a multi-view image decoding device that decodes the multi-view image. As illustrated in FIG. 19, a multi-view image decoding device 610 includes an inverse multiplexing unit 611, a decoding unit 612, and a decoding unit 613.

The inverse multiplexing unit 611 inversely multiplexes the multi-view image encoded stream in which the base view image encoded stream and the non-base view image encoded stream are multiplexed to extract the base view image encoded stream and the non-base view image encoded stream. The decoding unit 612 decodes the base view image encoded stream extracted from the inverse multiplexing unit 611 to obtain the base view image. The decoding unit 613 decodes the non-base view image encoded stream extracted by the inverse multiplexing unit 611 to obtain the non-base view image.

The decoding device 110 (FIG. 13) can be applied to the decoding unit 612 and the decoding unit 613 of the multi-view image decoding device 610. In this case, the multi-view image decoding device 610 sets a quantization parameter from the difference value between the quantization parameter set by the encoding unit 601 and the quantization parameter set by the encoding unit 602, and performs inverse quantization.

### (Application to Hierarchical Image Encoding/Hierarchical Image Decoding)

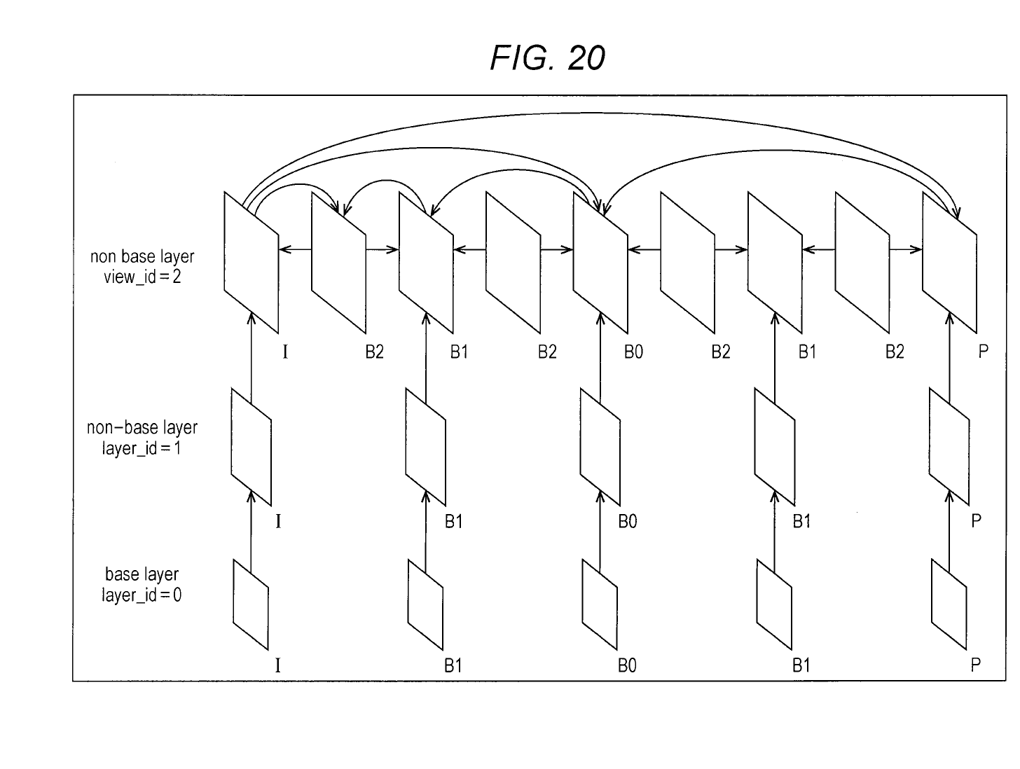

The above-described series of processing can be applied to hierarchical image encoding/hierarchical image decoding. FIG. 20 illustrates an example of a multi-view image encoding system.

As illustrated in FIG. 20, a hierarchical image includes a plurality of layers of images such that a predetermined parameter has a scalable function, and a predetermined one layer of the plurality of layers is specified as a base layer image. Other layer images than the base layer image are treated as non-base layer images.

When hierarchical image encoding like FIG. 20 is performed, in each layer (the same layer), a difference between quantization parameters can be obtained:

### (1) Base-Layer:

(1-1) dQP(base layer)=Current_CU_QP(base layer)−LCU_QP(base layer)
(1-2) dQP(base layer)=Current_CU_QP(base layer)−Previsous_CU_QP(base layer)
(1-3) dQP(base layer)=Current_CU_QP(base layer)−Slice_QP(base layer)

### (2) Non-Base-Layer:

(2-1) dQP(non-base layer)=Current_CU_QP(non-base layer)−LCU_QP(non-base layer)
(2-2) dQP(non-base layer)=CurrentQP(non-base layer)−PrevisousQP(non-base layer)
(2-3) dQP(non-base layer)=Current_CU_QP(non-base layer)−Slice_QP(non-base layer)

When hierarchical encoding is performed, a difference between quantization parameters in layers (different layers) can be obtained:

### (3) Base-Layer/Non-Base Layer:

(3-1) dQP(inter-layer)=Slice_QP(base layer)−Slice_QP(non-base layer)
(3-2) dQP(inter-layer)=LCU_QP(base layer)−LCU_QP(non-base layer)

### (4) Non-Base Layer/Non-Base Layer:

(4-1) dQP(inter-layer)=Slice_QP(non-base layer i)−Slice_QP(non-base layer j)
(4-2) dQP(inter-layer)=LCU_QP(non-base layer i)−LCU_QP(non-base layer j)

In this case, the above-described (1) to (4) can be combined. For example, in the non-base layer, a technique of obtaining a difference of the quantization parameters between the base layer and the non-base layer in a slice level (3-1 and 2-3 are combined), and a technique of obtaining a difference of the quantization parameters between the base layer and the non-base layer in an LCU level (3-2 and 2-1 are combined) can be considered. As described above, by repetitively applying of a difference, the encoding efficiency can be improved even if the hierarchical encoding is performed.

Similarly to the above-described techniques, a flag that identifies whether there is a dQP in which a value is not 0 can be set to each dQP.

### (Scalable Parameter)

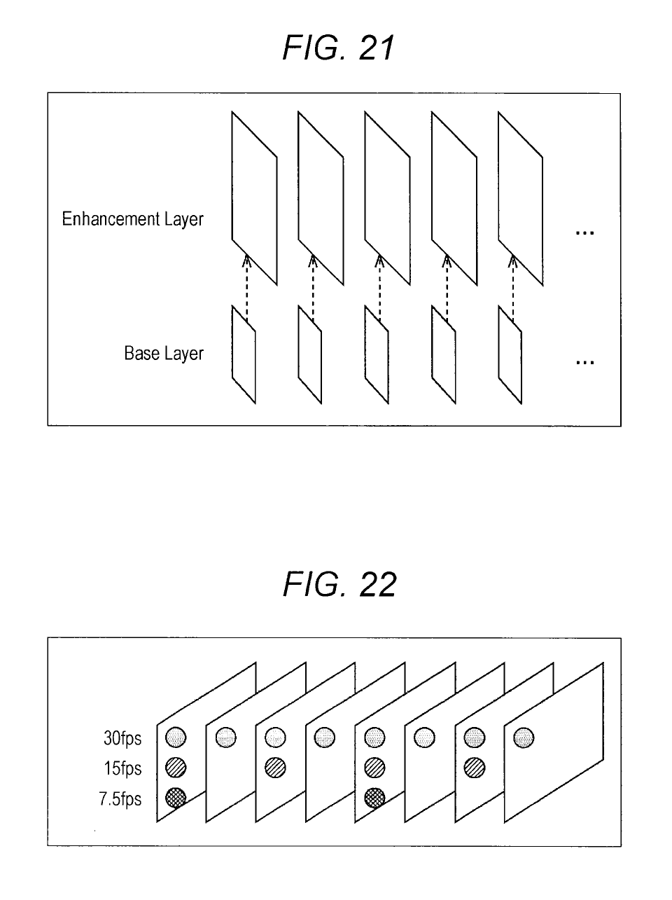

In such hierarchical image encoding/hierarchical image decoding (scalable encoding/scalable decoding), a parameter having a scalable function is arbitrary. For example, a spatial resolution as illustrated in FIG. 21 may be employed as the parameter (spatial scalability). In this spatial scalability, the resolution of the image is different in each layer. That is, in this case, as illustrated in FIG. 21, each picture is hierarchized into two hierarchies of a base layer having spatially lower resolution than an original image, and an enhancement layer that can obtain the original spatial resolution by being combined with the base layer. Of course, this number of hierarchies is an example, and the picture can be hierarchized into any number of hierarchies.

Further, as a parameter having the scalability, a temporal scalability as illustrated in FIG. 22 may be applied. In this temporal scalability, the frame rate is different in each layer. That is, in this case, as illustrated in FIG. 22, each picture is hierarchized into two hierarchies of a base layer having a lower frame rate than the original moving image, and an enhancement layer that obtains the original frame rate by being combined with the base layer. Of course, this number of hierarchies is an example, and the picture can be hierarchized into any number of hierarchies.

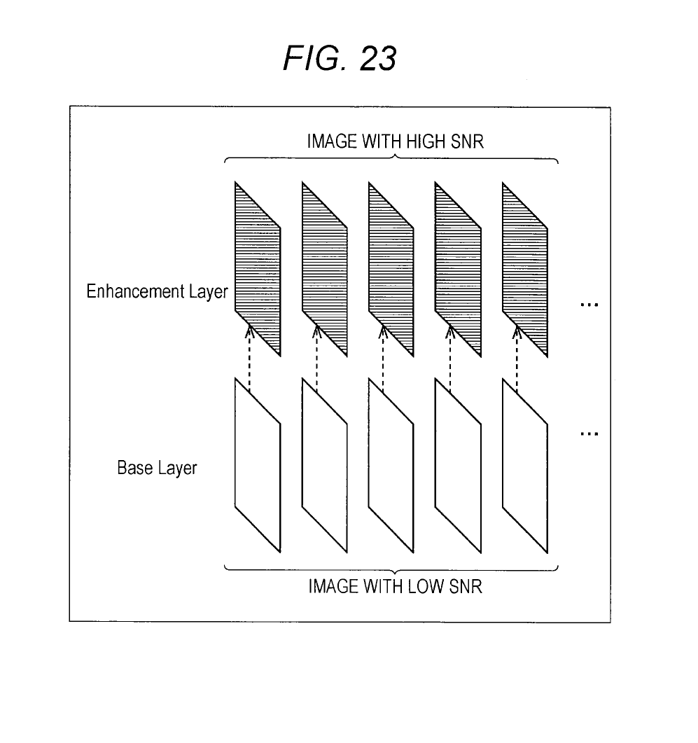

Further, as the parameter having the scalability, a signal-to-noise ratio (SNR) may be applied (SNR scalability), for example. In the case of the SNR scalability, the SN ratio is different in each layer. That is, in this case, as illustrated in FIG. 23, each picture is hierarchized into two hierarchies of a base layer having a lower SNR than an original image, and an enhancement layer that can obtain the original SNR by being combined with the base layer. Of course, this number of hierarchies is an example, and the picture can be hierarchized into any number of hierarchies.

Further, the parameter having the scalability may be a parameter other than the above examples. For example, as the parameter having the scalability, a bit depth can be used (bit-depth scalability). In the case of the bit-depth scalability, the bit depth is different in each layer. In this case, the base layer is made of an 8-bit image, and the enhancement layer is added thereto, whereby a 10-bit image can be obtained.

Further, as the parameter having the scalability, a chroma format can be used (chroma scalability). In the case of the chroma scalability, the chroma format is different in each layer. In this case, for example, the base layer is made of a component image in a 4:2:0 format, and the enhancement layer is added thereto, whereby a component image in the 4:2:2 format can be obtained.

### (Configuration Example of Hierarchical Image Encoding Device)

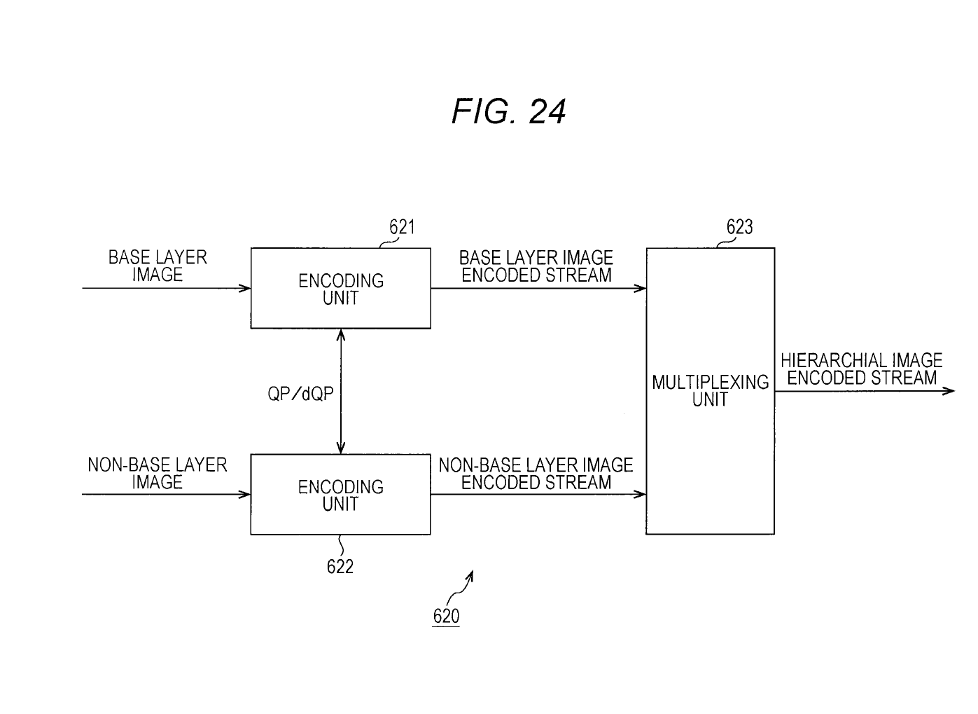

FIG. 24 is a diagram illustrating a hierarchical image encoding device that encodes the hierarchical image. As illustrated in FIG. 24, a hierarchical image encoding device 620 includes an encoding unit 621, encoding unit 622, and a multiplexing unit 623.

The encoding unit 621 encodes a base layer image to generate a base layer image encoded stream. The encoding unit 622 encodes a non-base layer image to generate a non-base layer image encoded stream. The multiplexing unit 623 multiplexes the base layer image encoded stream generated in the encoding unit 621 and the non-base layer image encoded stream generated in the encoding unit 622 to generate a hierarchical image encoded stream.

The encoding device 10 (FIG. 1) can be applied to the encoding unit 621 and the encoding unit 622 of the hierarchical image encoding device 620. In this case, the hierarchical image encoding device 620 sets and transmits a difference value between a quantization parameter set by the encoding unit 621 and a quantization parameter set by the encoding unit 622.

### (Configuration Example of Hierarchical Image Decoding Device)

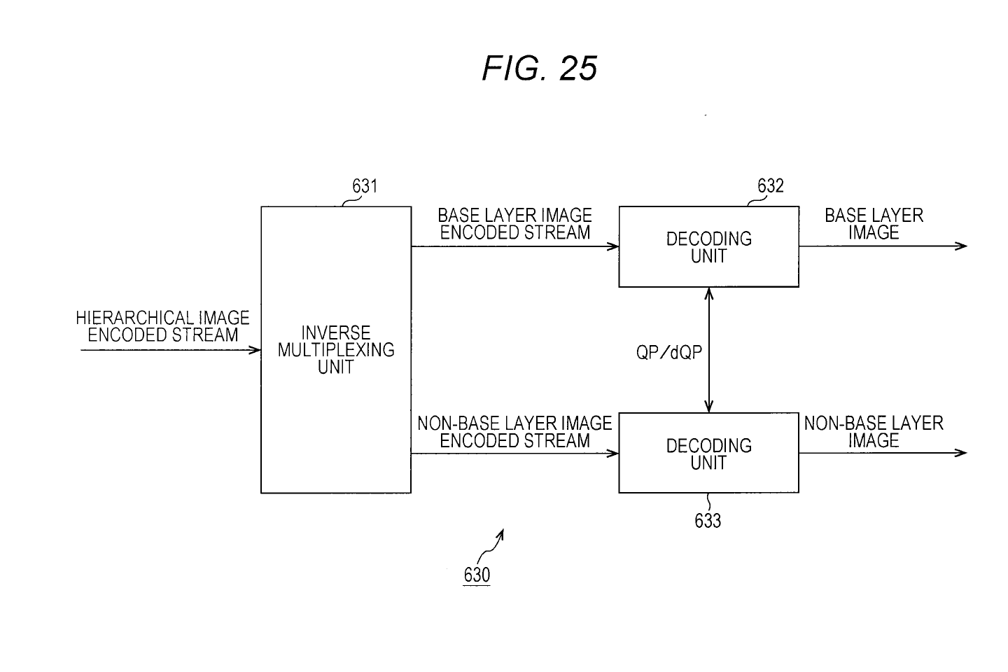

FIG. 25 is a diagram illustrating a hierarchical image decoding device that decodes the hierarchical image. As illustrated in FIG. 25, a hierarchical image decoding device 630 includes an inverse multiplexing unit 631, a decoding unit 632, and a decoding unit 633.

The inverse multiplexing unit 631 inversely multiplexes the hierarchical image encoded stream in which the base layer image encoded stream and the non-base layer image encoded stream are multiplexed to extract the base layer image encoded stream and the non-base layer image encoded stream. The decoding unit 632 decodes the base layer image encoded stream extracted by the inverse multiplexing unit 631 to obtain a base layer image. The decoding unit 633 decodes the non-base layer image encoded stream extracted by the inverse multiplexing unit 631 to obtain a non-base layer image.

The decoding device 110 (FIG. 13) can be applied to the decoding unit 632 and the decoding unit 633 of the hierarchical image decoding device 630. In this case, the hierarchical image decoding device 630 sets a quantization parameter from a difference value between a quantization parameter set by the encoding unit 621 and a quantization parameter set by the encoding unit 622 to perform inverse quantization.

(Description of Computer to which Present Technology is Applied)

The above-described series of processing can be executed by hardware or software. When the series of processing are performed by software, a program that configures the software is installed in a computer. Here, examples of the computer include a computer incorporated in dedicated hardware, and a general-purpose personal computer that can execute various functions by installing various programs.

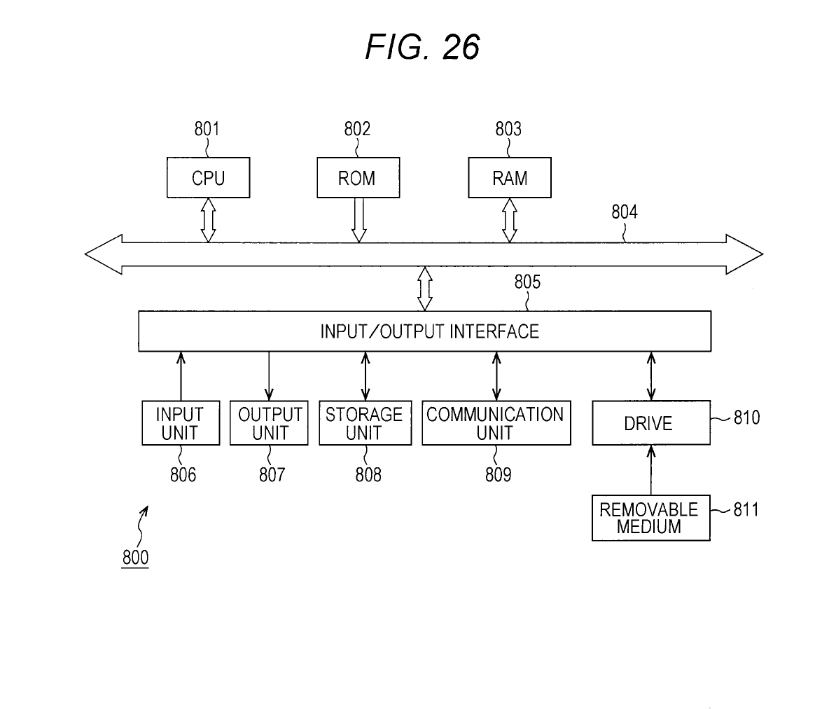

FIG. 26 is a block diagram illustrating a configuration example of hardware of a computer that executes the above series of processing by a program.

In the computer, a central processing unit (CPU) 801, a read only memory (ROM) 802, a random access memory (RAM) 803 are mutually connected by a bus 804.

Further, an input/output interface 805 is connected to the bus 804. An input unit 806, an output unit 807, a storage unit 808, a communication unit 809, and a drive 810 are connected to the input/output interface 805.

The input unit 806 is formed with a keyboard, a mouse, a microphone, and the like. The output unit 807 is formed with a display, a speaker, and the like. The storage unit 808 is formed with a hard disk, a non-volatile memory, and the like. The communication unit 809 is formed with a network interface, and the like. The drive 810 drives a removable medium 811, such as a magnetic disk, an optical disk, a magneto-optical disk, or a semiconductor memory.

In the computer configured as described above, the CPU 801 loads the program stored in the storage unit 808 through the input/output interface 805 and the bus 804 to the RAM 803 and executes the program, thereby to perform the above-described series of processing.

The program executed by the computer (CPU 801) can be provided by being recorded in the removable medium 811 as a package medium. Further, the program can be provided through a wired or wireless transmission medium, such as a local area network, the Internet, or digital satellite broadcasting.

In the computer, the removable medium 811 is mounted to the drive 810, whereby the program can be installed to the storage unit 808 through the input/output interface 805. Further, the program is received by the communication unit 809 through a wired or wireless transmission medium, and can be installed to the storage unit 808. Alternatively, the program can be installed to the ROM 802 or the storage unit 808 in advance.

Note that the program executed by the computer may be a program, the processing of which is performed in time series along the order described in the specification, or may be a program, the processing of which is performed in parallel or at necessary timing such as when being called.

### (Configuration Example of Television Device)

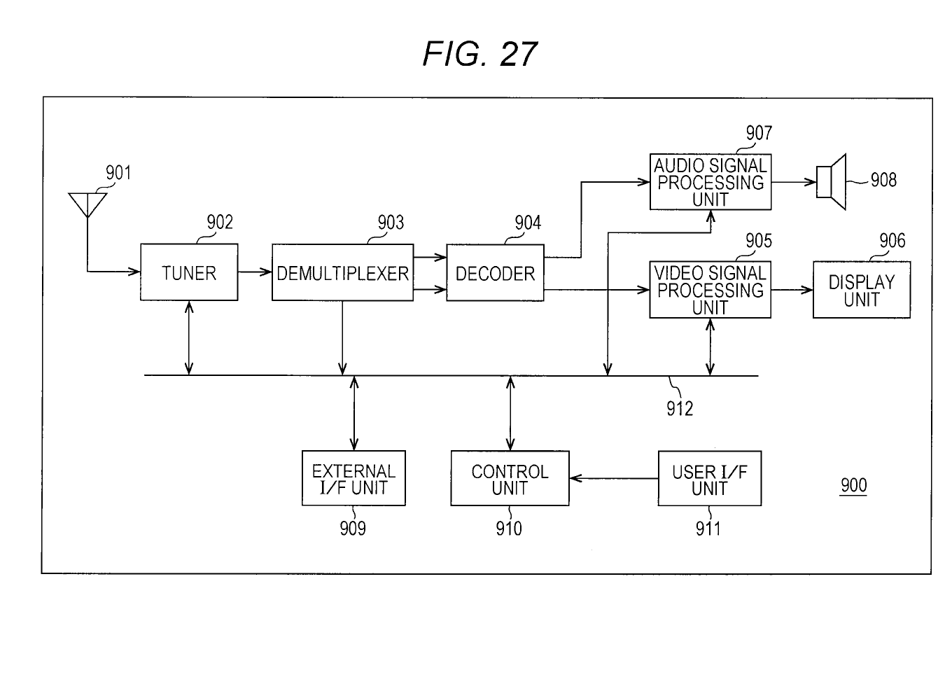

FIG. 27 exemplarily illustrates a schematic configuration of a television device to which the present technology is applied. A television device 900 includes an antenna 901, a tuner 902, a demultiplexer 903, a decoder 904, a video signal processing unit 905, a display unit 906, an audio signal processing unit 907, a speaker 908, and an external interface unit 909. Further, the television device 900 includes a control unit 910, a user interface unit 911, and the like.

The tuner 902 selects a desired channel from a broadcast wave signal received by the antenna 901 and performs decoding, and outputs an obtained encoded bit stream to the demultiplexer 903.

The demultiplexer 903 extracts video and audio packets of a program to be viewed from the encoded bit stream, and outputs data of the extracted packets to the decoder 904. Further, the demultiplexer 903 supplies the packet of data such as electronic program guide (EPG) or the like to the control unit 910. Note that, when the data has been scrambled, a demultiplexer or the like descrambles the data.

The decoder 904 applies decoding processing to the packets, and outputs video data generated through the decoding processing to the video signal processing unit 905 and outputs audio data to the audio signal processing unit 907.

The video signal processing unit 905 performs noise removal or video processing according to user setting with respect to the video data. The video signal processing unit 905 generates video data of the program to be displayed in the display unit 906, image data by processing based on an application supplied through the network, and the like. Further, the video signal processing unit 905 generates video data for displaying a menu screen such as selection of items, and the like, and superimposes the video data on the video data of the program. The video signal processing unit 905 generates a drive signal based on the video data generated as described above to drive the display unit 906.

The display unit 906 drives a display device (for example, a liquid crystal display element, or the like) based on the drive signal from the video signal processing unit 905 to display video of the program, and the like.

The audio signal processing unit 907 applies predetermined processing such as noise removal to the audio data, performs D/A conversion processing and amplification processing of the processed audio data, and supplies the audio data to the speaker 908 to output the audio.

The external interface unit 909 is an interface for being connected with an external device or the network, and transmits/receives video data, audio data, and the like.

The user interface unit 911 is connected to the control unit 910. The user interface unit 911 is configured from an operation switch, a remote control signal receiving unit, and the like, and supplies an operation signal according to a user operation to the control unit 910.

The control unit 910 is configured from a central processing unit (CPU), a memory, and the like. The memory stores a program executed by the CPU, various data necessary for the CPU to perform processing, the EPG data, data acquired through the network, and the like. The program stored in the memory is read and executed by the CPU at predetermined timing, such as at start-up of the television device 900. The CPU executes the program to control respective units so that the television device 900 performs an operation according to the user operation.

Note that, in the television device 900, a bus 912 is provided for connecting the tuner 902, the demultiplexer 903, the video signal processing unit 905, the audio signal processing unit 907, the external interface unit 909, and the like, and the control unit 910.

In the television device configured as described above, the function of the decoding device (decoding method) of the present application is provided to the decoder 904. Therefore, an encoded stream subjected to appropriate sign data hiding processing can be decoded.

### (Configuration Example of Mobile Phone)

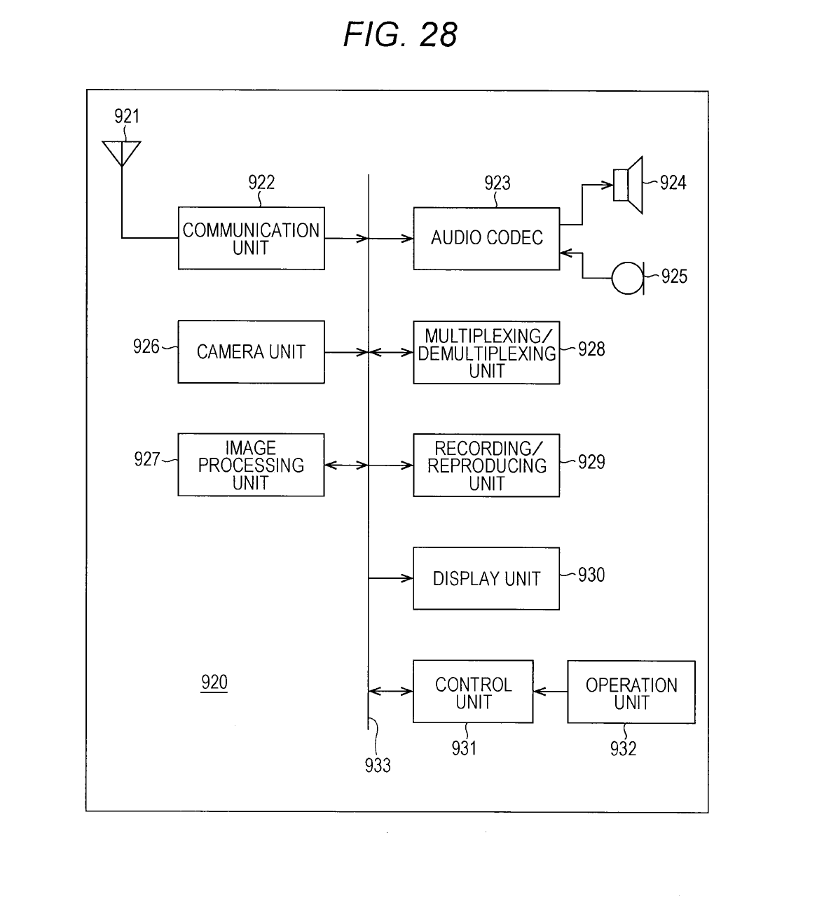

FIG. 28 exemplarily illustrates a schematic configuration of a mobile phone to which the present technology is applied. A mobile phone 920 includes a communication unit 922, an audio codec 923, a camera unit 926, an image processing unit 927, a multiplexing/demultiplexing unit 928, a recording/reproducing unit 929, a display unit 930, and a control unit 931. These units are mutually connected through a bus 933.

Further, an antenna 921 is connected to the communication unit 922. A speaker 924 and a microphone 925 are connected to the audio codec 923. An operation unit 932 is connected to the control unit 931.

The mobile phone 920 performs various operations, such as transmission and reception of audio signals, transmission and reception of electronic mails or image data, image capturing, and data recording, in various modes including a voice call mode, and a data communication mode.

In the voice call mode, an audio signal generated by the microphone 925 is converted into audio data and compressed in the audio codec 923, and is supplied to the communication unit 922. The communication unit 922 performs modulation processing and frequency conversion processing, and the like of the audio data to generate a transmission signal. Further, the communication unit 922 supplies the transmission signal to the antenna 921, and transmits the signal to a base station (not illustrated). Further, the communication unit 922 performs amplification, frequency conversion processing, and demodulation processing of a reception signal received by the antenna 921, and supplies obtained audio data to the audio codec 923. The audio codec 923 expands the audio data and converts the audio data into an analog audio signal, and outputs the audio signal to the speaker 924.

Further, when an electronic mail is transmitted in the data communication mode, the control unit 931 receives character data input by an operation of the operation unit 932, and displays the input characters on the display unit 930. Further, the control unit 931 generates an electronic mail data based on a user instruction or the like in the operation unit 932, and supplies the generated electronic mail data to the communication unit 922. The communication unit 922 performs modulation processing, frequency conversion processing, and the like of the electronic mail data, and transmits an obtained transmission signal through an antenna 921. Further, the communication unit 922 performs amplification, frequency conversion processing, demodulation processing, and the like of a reception signal received through the antenna 921 to restore the electronic mail. The communication unit 922 supplies the electronic mail data to the display unit 930, and displays the content of the mail.

Note that the mobile phone 920 can store the received electronic mail data in a storage medium by the recording/reproducing unit 929. The storage medium is an arbitrary rewritable storage medium. For example, the storage medium is a RAM, a semiconductor memory such as a built-in type flash memory, or a removable medium such as a hard disk, a magnetic disk, a magneto-optical disk, an optical disk, a USB memory, or a memory card.

When image data is transmitted in the data communication mode, image data generated in the camera unit 926 is supplied to the image processing unit 927. The image processing unit 927 performs encoding processing of the image data to generate encoded data.

The multiplexing/demultiplexing unit 928 multiplexes the encoded data generated in the image processing unit 927 and the audio data supplied from the audio codec 923 in a predetermined system, and supplies the multiplexed data to the communication unit 922. The communication unit 922 performs modulation processing, frequency conversion processing, and the like of the multiplexed data, and transmits an obtained transmission signal via the antenna 921. Further, the communication unit 922 performs amplification, frequency conversion processing, demodulation processing, and the like of a reception signal received by the antenna 921 to restore multiplexed data. The communication unit 922 supplies the multiplexed data to the multiplexing/demultiplexing unit 928. The multiplexing/demultiplexing unit 928 demultiplexes the multiplexed data, and supplies encoded data to the image processing unit 927 and supplies audio data to the audio codec 923. The image processing unit 927 performs decoding processing of the encoded data to generate image data. The image processing unit 927 supplies the image data to the display unit 930 to display a received image. The audio codec 923 coverts the audio data into an analog audio signal, and supplies the analog audio signal to the speaker 924 to output received audio.

In the mobile phone device configured as described above, the function of the encoding device and the decoding device (encoding method and decoding method) of the present application are provided in the image processing unit 927. Therefore, the sign data hiding processing can be appropriately performed. Further, an encoded stream subjected to appropriate sign data hiding processing can be decoded.

### (Configuration Example of Recording/Reproducing Device)

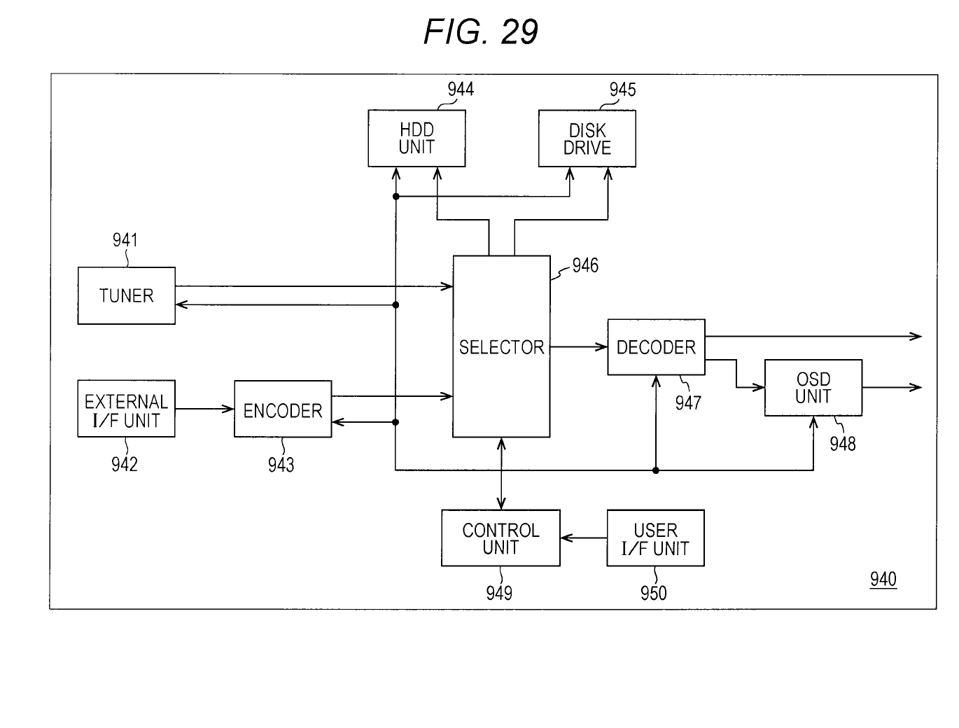

FIG. 29 exemplarily illustrates a schematic configuration of a recording/reproducing device to which the present technology is applied. The recording/reproducing device 940 records audio data and video data of received broadcast program in a recording medium, and provides the recorded data to the user at timing according to an instruction of the user. Further, the recording/reproducing device 940 can acquire audio data and video data from another device, and record the data in the recording medium. Further, the recording/reproducing device 940 decodes and outputs the audio data and video data recorded in the recording medium, thereby to display an image and to output audio in a monitor device, or the like.

The recording/reproducing device 940 includes a tuner 941, an external interface unit 942, an encoder 943, a hard disk drive (HDD) 944, a disk drive 945, a selector 946, a decoder 947, an on-screen display (OSD) unit 948, a control unit 949, and a user interface unit 950.

The tuner 941 selects a desired channel from a broadcast signal received by an antenna (not illustrated). The tuner 941 outputs an encoded bit stream obtained such that a reception signal of the desired channel is demodulated to the selector 946.

The external interface unit 942 is configured from at least one of an IEEE 1394 interface, a network interface unit, a USB interface, and a flash memory interface. The external interface unit 942 is an interface for being connected to an external device, the network, a memory card, or the like, and performs transmission/reception of video data, audio data, and the like to be recorded.

When the video data and audio data received from the external interface unit 942 are not encoded, the encoder 943 performs encoding in a predetermined system, and outputs an encoded bit stream to the selector 946.

The HDD unit 944 records content data such as video and audio, various programs, and other data in a built-in hard disk, and reads out these pieces of data from the hard disk at the time of reproduction.

The disk drive 945 records and reproduces a signal with respect to a mounted optical disk data. The optical disk is, for example, a DVD disk (DVD-video, DVD-RAM, DVD-R, DVD-RW, DVD+R, or DVD+RW), or a Blu-ray (registered trademark) disk.

At the time of recording video and audio, the selector 946 selects an encoded bit stream from the tuner 941 or the encoder 943, and supplies the selected encoded bit stream to any of HDD unit 944 and the disk drive 945. At the time of reproducing the video and voice, the selector 946 supplies the encoded bit stream output from the HDD unit 944 or the disk drive 945 to the decoder 947.

The decoder 947 performs decoding processing of the encoded bit stream. The decoder 947 supplies video data generated through the decoding processing to the OSD unit 948. Further, the decoder 947 outputs audio data generated through the decoding processing.

The OSD unit 948 generates video data for displaying a menu screen such as selection of items, superimposes and outputs the video data on the video data output from the decoder 947.

The user interface unit 950 is connected to the control unit 949. The user interface unit 950 is configured from an operation switch, a remote control signal receiving unit, and the like, and supplies an operation signal according to a user operation to the control unit 949.

The control unit 949 is configured from a CPU, a memory, and the like. The memory stores a program executed by the CPU, and various data necessary for the CPU to perform processing. The program stored in the memory is read and executed by the CPU at predetermined timing, such as at start-up of the recording/reproducing device 940. The CPU executes the program to control respective units so that the recording/reproducing device 940 performs an operation according to the user operation.

In the recording/reproducing device configured as described above, a function of the decoding device (decoding method) of the present application is provided in the decoder 947. Therefore, the encoded stream subjected to appropriate sign data hiding processing can be decoded.

### (Configuration Example of Imaging Device)

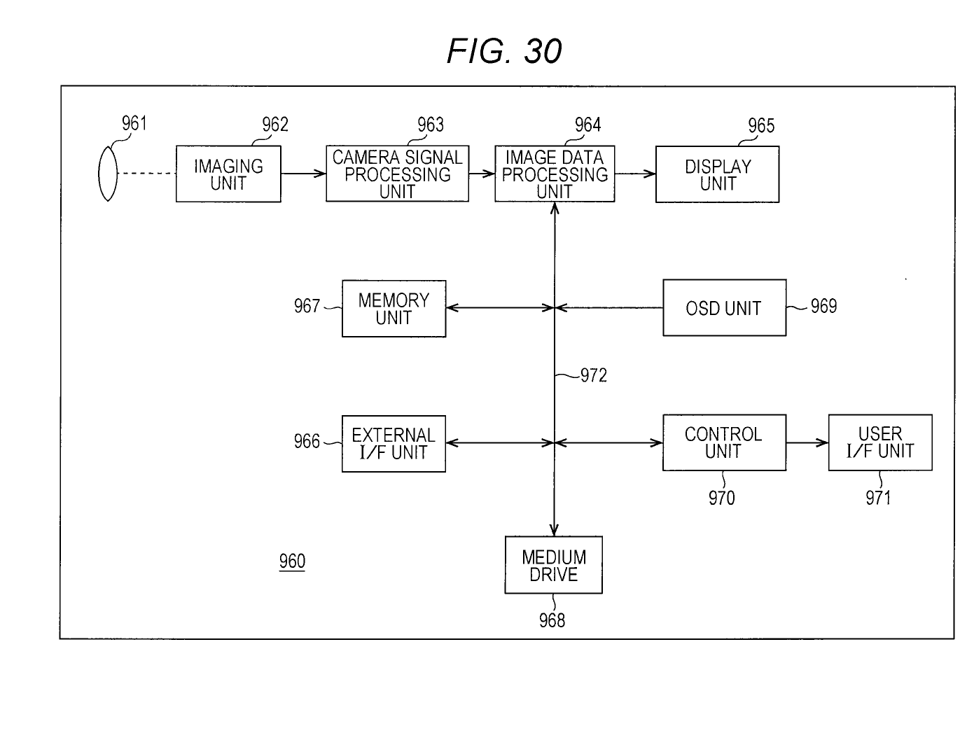

FIG. 30 exemplarily illustrates a schematic configuration of an imaging device to which the present technology is applied. An imaging device 960 images an object, and displays an image of the object in a display unit or records the image in a recording medium as image data.

The imaging device 960 includes an optical block 961, an imaging unit 962, a camera signal processing unit 963, an image data processing unit 964, a display unit 965, an external interface unit 966, a memory unit 967, a medium drive 968, an OSD unit 969, and a control unit 970. Further, a user interface unit 971 is connected to the control unit 970. Further, the image data processing unit 964, the external interface unit 966, the memory unit 967, the medium drive 968, the OSD unit 969, the control unit 970, and the like are connected through a bus 972.

The optical block 961 is configured from a focus lens and a diaphragm mechanism. The optical block 961 forms an optical image of an object on an imaging surface of the imaging unit 962. The imaging unit 962 is configured from a CCD or CMOS sensor, and generates an electrical signal by photoelectric conversion according to the optical image, and supplies the electrical signal to the camera signal processing unit 963.

The camera signal processing unit 963 applies various types of camera signal processing, such as knee correction, gamma correction, and color correction, to the electrical signal supplied from the imaging unit 962. The camera signal processing unit 963 outputs image data subjected to the camera signal processing to the image data processing unit 964.

The image data processing unit 964 performs encoding processing of the image data supplied from the camera signal processing unit 963. The image data processing unit 964 outputs encoded data generated through the encoding processing to the external interface unit 966 and the medium drive 968. Further, the image data processing unit 964 performs decoding processing of the encoded data supplied from the external interface unit 966 and the medium drive 968. The image data processing unit 964 outputs image data generated through the decoding processing to the display unit 965. The image data processing unit 964 supplies the image data supplied from the camera signal processing unit 963 to the display unit 965, and superimposes the display data obtained from the OSD unit 969 on the image data and supplies the superimposed data to the display unit 965.

The OSD unit 969 generates display data such as a menu screen or an icon formed with marks, characters, and figures, and outputs the display data to the image data processing unit 964.

The external interface unit 966 is configured from a USB input/output terminal, and the like, for example, and is connected to a printer when printing of an image is performed. Further, a drive is connected to the external interface unit 966, as needed, and a removable medium such as a magnetic disk, or an optical disk is appropriately mounted thereto. A computer program read from the removable medium is installed, as needed. Further, the external interface unit 966 includes a network interface connected to a predetermined network such as a LAN or the Internet. The control unit 970 can read encoded data from the medium drive 968 according to an instruction from the user interface unit 971, for example, and can supply the encoded data to another device connected through the network from the external interface unit 966. Further, the control unit 970 can acquire, through the external interface unit 966, encoded data and image data supplied from another device through the network, and can supply the data to the image data processing unit 964.

As a recording medium driven in the medium drive 968, for example, an arbitrary readable-writable removable medium, such as a magnetic disk, a magneto-optical disk, an optical disk, or a semiconductor memory, is used. Further, the recording medium may also be any type of removable medium, and may be a tape device, a disk, or a memory card. Of course, the recording medium may be a non-contact integrated circuit (IC) card, or the like.

Further, the medium drive 968 and the recording medium may be integrated and configured from a non-transportable storage medium such as a built-in type hard disk drive or a solid state drive (SSD), for example.

The control unit 970 is configured from a CPU. The memory unit 967 stores a program executed by the control unit 970, and various data necessary for the control unit 970 to perform processing. The program stored in the memory unit 967 is read and executed by the control unit 970 at predetermined timing, such as at start-up of the imaging device 960. The control unit 970 executes the program to control respective units so that the imaging device 960 performs an operation according to the user operation.

In the imaging device configured as described above, the function of the encoding device and the decoding device (the encoding method and the decoding method) of the present application is provided to the image data processing unit 964. Therefore, the sign data hiding processing can be appropriately performed. Further, an encoded stream subjected to appropriate sign data hiding processing can be decoded.

### <Application Example of Scalable Encoding>

### (First System)

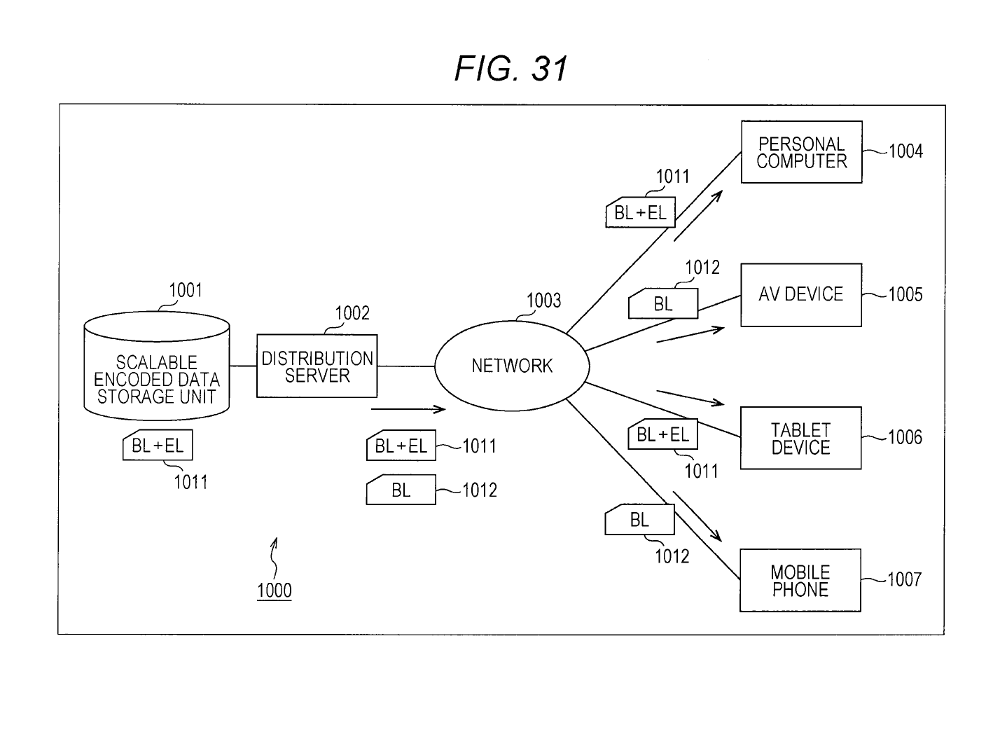

Next, a specific use example of scalable encoded data subjected to scalable encoding will be described. The scalable encoding is used for selection of data to be transmitted, as illustrated in the example of FIG. 31.

In a data transmission system 1000 illustrated in FIG. 31, a distribution server 1002 reads scalable encoded data stored in a scalable encoded data storage unit 1001, and distributes the scalable encoded data to terminal devices such as a personal computer 1004, an AV device 1005, a tablet device 1006, and a mobile phone 1007, through a network 1003.

At that time, the distribution server 1002 selects and transmits encoded data having appropriate quality according to the capability or a communication environment of the terminal device. Even if the distribution server 1002 transmits unnecessarily high-quality data, the terminal device may not obtain the high-quality image, and such transmission may be a cause of occurrence of a delay or overflow. In addition, such transmission may unnecessarily occupy a communication band, or may unnecessarily increase a load of the terminal device. On the other hand, if the distribution server 1002 transmits unnecessarily low-quality data, the terminal device may not be able to obtain an image with sufficient image quality. Therefore, the distribution server 1002 appropriately reads and transmits scalable encoded data stored in the scalable encoded data storage unit 1001 as encoded data having appropriate quality for the capability or the communication environment of the terminal device.

For example, assume that the scalable encoded data storage unit 1001 stores scalable encoded data (BL+EL) 1011, which has been scalably encoded. The scalable encoded data (BL+EL) 1011 is encoded data including both of abase layer and an enhancement layer, and is data from which both of a base layer image and an enhancement layer image can be obtained by decoding.

The distribution server 1002 selects an appropriate layer according to the capability or the communication environment of the terminal device, to which the data is transmitted, and reads the layer. For example, the distribution server 1002 reads the high-quality scalable encoded data (BL+EL) 1011 from the scalable encoded data storage unit 1001 for the personal computer 1004 or the tablet device 1006 having high processing capability, and transmits the scalable encoded data as it is. In contrast, for example, the distribution server 1002 extracts data of the base layer from the scalable encoded data (BL+EL) 1011 for the AV device 1005 or the mobile phone 1007 having low processing capability, and transmits data as scalable encoded data (BL) 1012 that has the same content as the scalable encoded data (BL+EL) 1011 but has lower quality than the scalable encoded data (BL+EL) 1011.

As described above, by use of the scalable encoded data, the data amount can be easily adjusted. Therefore, occurrence of a delay or overflow can be suppressed, and an unnecessary increase in the load of the terminal device or a communication medium can be suppressed. Further, in the scalable encoded data (BL+EL) 1011, interlayer redundancy is decreased. Therefore, the data amount can be decreased than a case where the encoded data of each layer is separated data. Therefore, a storage area of the scalable encoded data storage unit 1001 can be more efficiently used.

Like the personal computer 1004 or the mobile phone 1007, various devices can be applied to the terminal device. Therefore, performance of hardware of the terminal device varies depending on the device. Further, an application executed by the terminal device also varies, and thus performance of its software also varies. Further, as the network 1003 serving as a communication medium, every communication line network, such as the Internet and a local area network (LAN) including wired or wireless communication, or both of them can be applied, and data transmission capability varies. Further, the data transmission capability may be changed due to another communication.

Therefore, the distribution server 1002 may perform communication with the terminal device that is a transmission destination of data, before starting data transmission, and obtain information related to the capability of the terminal device such as hardware performance of the terminal device and performance of an application (software) executed by the terminal device, and information related to the communication environment such as an available bandwidth of the network 1003. Then, the distribution server 1002 may select an appropriate layer based on the obtained information.

Note that the extraction of a layer may be performed in the terminal device. For example, the personal computer 1004 may decode the transmitted scalable encoded data (BL+EL) 1011 and display the base layer image, or the enhancement layer image. Further, for example, the personal computer 1004 may extract the scalable encoded data (BL) 1012 of the base layer from the transmitted scalable encoded data (BL+EL) 1011, store the scalable encoded data (BL) 1012, transmit the scalable encoded data (BL) 1012 to another device, or decode the scalable encoded data (BL) 1012 to display the base layer image.

The number of the scalable encoded data storage units 1001, the distribution servers 1002, the networks 1003, and the terminal devices are arbitrary. Further, in the above description, an example in which the distribution server 1002 transmits data to the terminal device has been described. However, the use example is not limited to the example. The data transmission system 1000 can be applied to any system as long as the system selects and transmits an appropriate layer according to the capability or the communication environment of the terminal device in transmitting the encoded data subjected to the scalable encoding to the terminal device.

### (Second System)

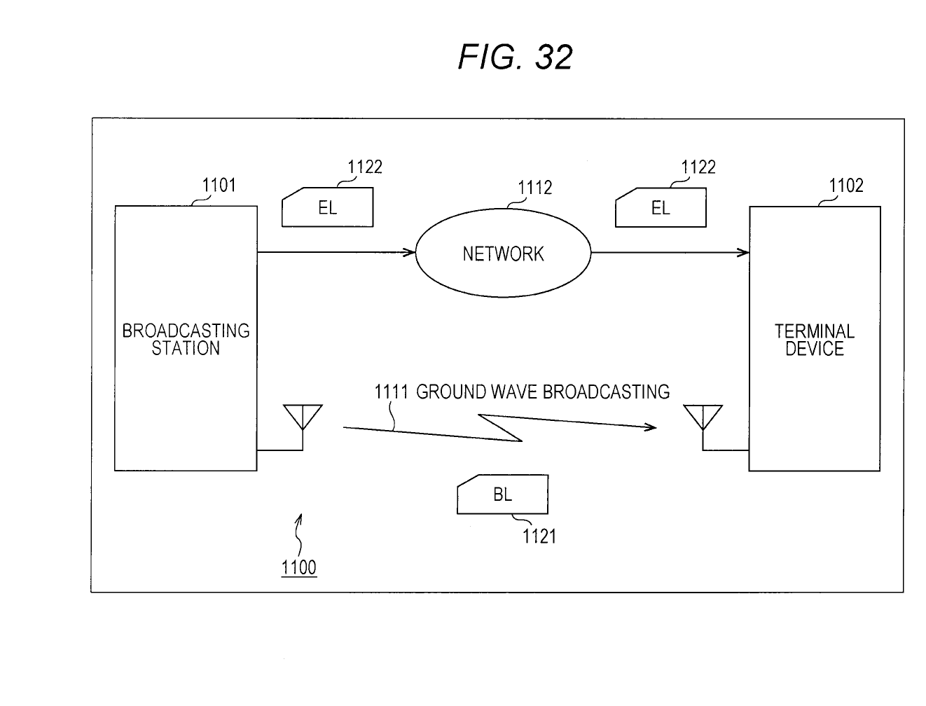

Further, scalable encoding is used for transmission through a plurality of communication media, as illustrated in the example of FIG. 32.

In a data transmission system 1100 illustrated in FIG. 32, a broadcasting station 1101 transmits scalable encoded data (BL) 1121 of a base layer with ground wave broadcasting 1111. Further, the broadcasting station 1101 transmits scalable encoded data (EL) 1122 of an enhancement layer through an arbitrary network 1112 formed of a wired or wireless, or wired and wireless communication network (for example, packetizes and transmits the data).

The terminal device 1102 has a function to receive the ground wave broadcasting 1111 broadcasted by the broadcasting station 1101, and receives the scalable encoded data (BL) 1121 of a base layer transmitted through the ground wave broadcasting 1111. Further, the terminal device 1102 has a function to perform communication through the network 1112, and receives the scalable encoded data (EL) 1122 of the enhancement layer transmitted through the network 1112.

The terminal device 1102 decodes the scalable encoded data (BL) 1121 of a base layer acquired through the ground wave broadcasting 1111 to obtain a base layer image, stores the scalable encoded data (BL) 1121, or transmits the scalable encoded data (BL) 1121 to another device, according to a user instruction, or the like.

Further, the terminal device 1102 combines the scalable encoded data (BL) 1121 of the base layer acquired through the ground wave broadcasting 1111 and the scalable encoded data (EL) 1122 of the enhancement layer acquired through the network 1112 to obtain scalable encoded data (BL+EL), decodes the scalable encoded data (BL+EL) to obtain an enhancement layer image, stores the scalable encoded data (BL+EL), or transmits the scalable encoded data (BL+EL) to another device, according to a user instruction, or the like.

As described above, the scalable encoded data can be transmitted through a different communication medium for each layer. Therefore, the load can be distributed, and occurrence of a delay or overflow can be suppressed.

Further, the communication medium used for transmission may be able to be selected for each layer according to the situation. For example, the scalable encoded data (BL) 1121 of the base layer having a relatively large data amount may be transmitted through a communication medium having a wide bandwidth, and the scalable encoded data (EL) 1122 of the enhancement layer having a relatively small data amount may be transmitted through a communication medium having a narrow bandwidth. Further, for example, the communication medium that transmits the scalable encoded data (EL) 1122 of the enhancement layer may be switched between the network 1112 and the ground wave broadcasting 1111 according to an available bandwidth of the network 1112. Of course, the same applied to data of an arbitrary layer.

With such control, an increase in the load in data transmission can be further suppressed.

The number of layers is arbitrary, and the number of communication media used for transmission is also arbitrary. Further, the number of terminal devices 1102 that are data distribution destination is also arbitrary. Further, in the above description, an example of broadcasting from the broadcasting station 1101 has been described. However, the use example is not limited to the example. The data transmission system 1100 can be applied to any system as long as the system divides the scalably encoded data into a plurality of data in layer units, and transmits the data through a plurality of lines.

### (Third System)

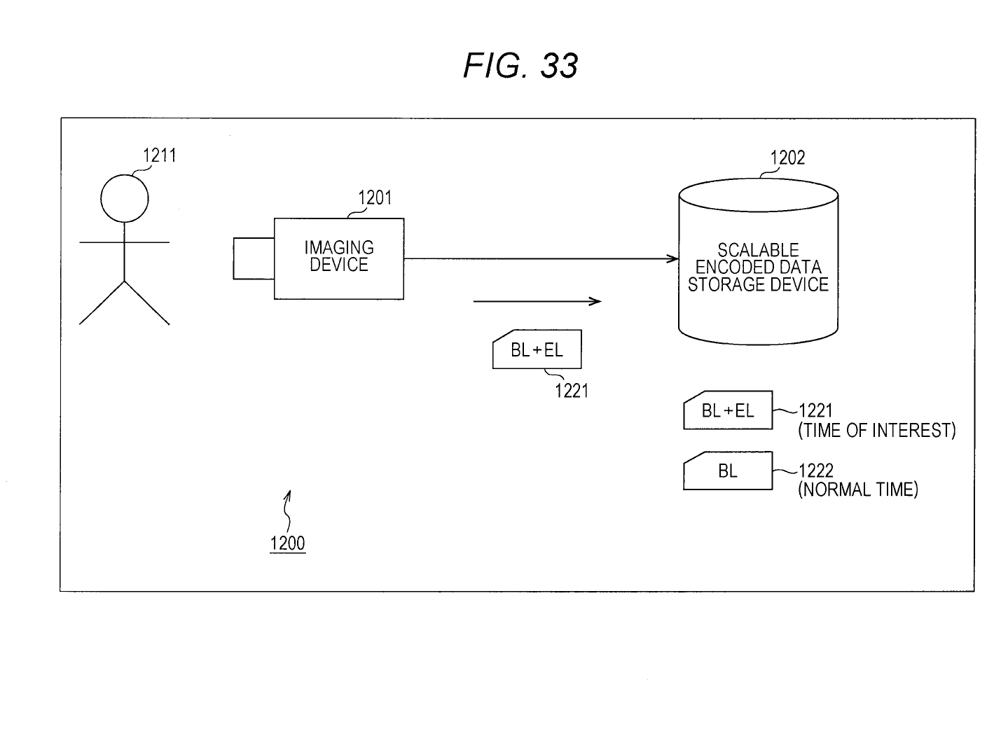

Further, scalable encoding is used for storage of encoded data, as illustrated in the example of FIG. 33.

In an imaging system 1200 illustrated in FIG. 33, an imaging device 1201 scalably encodes image data obtained by imaging an object 1211, and supplies the image data to a scalable encoded data storage device 1202 as scalable encoded data (BL+EL) 1221.

The scalable encoded data storage device 1202 stores the scalable encoded data (BL+EL) 1221 supplied from the imaging device 1201, with quality according to the situation. For example, at the normal time, the scalable encoded data storage device 1202 extracts data of a base layer from the scalable encoded data (BL+EL) 1221, and stores the data as scalable encoded data (BL) 1222 of the base layer having low quality and a small data mount. In contrast, for example, at the time of interest, the scalable encoded data storage device 1202 stores the scalable encoded data (BL+EL) 1221 having high quality and a large data amount as it is.

In doing so, the scalable encoded data storage device 1202 can store the image with high image quality, only when needed. Therefore, an increase in the data amount can be suppressed while a decrease in value of the image due to deterioration of the image quality is suppressed, whereby the use efficiency of a storage area can be improved.

For example, assume that the imaging device 1201 is a monitoring camera. When an object to be monitored (for example, a trespasser) does not appear in an imaged image (at the normal time), there is a high possibility that the content of the imaged image is not important. Therefore, a decrease in the data amount is given priority, and the image data (scalable encoded data) is stored with low quality. In contrast, when the object to be monitored appears in the imaged image as the object 1211 (at the time of interest), there is a high possibility that the content of the imaged image is important. Therefore, the image quality is given priority, and the image data scalable encoded data) is stored with high quality.

Note that whether it is the normal time or the time of interest may be determined such that the scalable encoded data storage device 1202 analyzes the image. Alternatively, the imaging device 1201 may perform determination, and transmit a determination result to the scalable encoded data storage device 1202.

Note that determination criteria of whether it is the normal time or the time of interest are arbitrary, and the content of an image of the determination criteria is arbitrary. Of course, conditions other than the content of an image may be used as the determination criteria. For example, the normal time and the time of interest may be switched according to the magnitude or a waveform of recorded audio, may be switched at every predetermined time, or may be switched according to an instruction from an outside such as a user instruction.

Further, a case of switching the normal time and the time of interest has been described. However, the number of the states is arbitrary. For example, three or more states, such as the normal time, the time of small interest, the time of interest, and the time of large interest, may be switched. However, the upper limit number of the states to be switched depends on the number of layers of the scalable encoded data.

Further, the imaging device 1201 may determine the number of layers of the scalable encoding according to a state. For example, at the normal time, the imaging device 1201 may generate the scalable encoded data (BL) 1222 having low quality and a small data amount, and supply the scalable encoded data (BL) 1222 to the scalable encoded data storage device 1202. Further, for example, at the time of interest, the imaging device 1201 may generate the scalable encoded data (BL+EL) 1221 having high quality and a large data amount, and supply the scalable encoded data (BL+EL) 1221 to the scalable encoded data storage device 1202.

In the above description, the monitoring camera has been exemplarily described. However, the use of the imaging system 1200 is arbitrary, and is not limited to the monitoring camera.

The present invention can be applied to a device used in transmitting/receiving image information (a bit stream) compressed by orthogonal transform such as discrete cosine transform, and motion compensation, like MPEG. H.26x. through a network medium, such as satellite broadcasting, cable TV, the Internet, or a mobile phone, or in processing the image information on a storage medium, such as an optical disk, a magnetic disk, or a flash memory.

Further, the encoding system in the present invention may be an encoding system using sign data hiding, other than the HEVC system.

Note that embodiments of the present technology are not limited to the above-described embodiments, and various changes can be made without departing from the gist of the present technology.

For example, the encoding device 10 may include a table in which each quantization parameter and a threshold of the sum of the absolute values of the non-zero orthogonal transform coefficients is associated with each other in the SPS, or the like, and transmits the table. In this case, the sign hiding decoding unit 135 of the decoding device 110 refers to the table, and sets the threshold corresponding to the quantization parameter included in the encoding information.

Note that, in this case, the encoding device 10 may transmit a table in which quantization parameters of predetermined intervals (for example, quantization parameters of five intervals) and thresholds are associated with each other, instead of transmitting a table in which all possible quantization parameters and thresholds are associated with each other. In this case, the sign hiding decoding unit 135 applies predetermined linear interpolation to the thresholds in the table, as needed, thereby to set the threshold corresponding to the quantization parameter included in the encoding information,

Further, in the HEVC standard, there is a technology called intra transform skipping that skips orthogonal transform processing in TU of luminance and color difference of 4×4 pixels. Details of this technology are described in JCTVC-I0408, and thus description is omitted. When the orthogonal transform processing is skipped by the intra transform skipping, information (residual information) output from the orthogonal transform unit 34 is not information of frequency region, and is information of pixel region. Therefore, when such information is operated, discontinuous pixels occur in a processing block and the pixels may be observed as noise in a decoded image. Therefore, when performing the intra transform skipping, the encoding device 10 does not perform the sign data hiding.

In this case, the encoding device 10 includes a flag indicating whether the intra transform skipping can be performed in the SPS and transmits the SPS. This flag is 1 when the intra transform skipping can be performed, and is 0 when the intra transform skipping cannot be performed. Further, the encoding device 10 transmits a flag indicating whether the orthogonal transform processing is skipped for each TU.

Therefore, the decoding device 110 determines whether performing the adding processing based on the flag indicating whether the orthogonal transform processing is skipped transmitted from the encoding device 10.

Further, the encoding device 10 may transmit application information that indicates whether common sign data hiding processing (adding processing corresponding thereto) is performed regardless of prediction mode, instead of transmitting the intra application information and the inter application information. In this case, when the application information indicates performing of the sign data hiding processing, the encoding device 10 performs the sign data hiding processing and the decoding device 110 performs the adding processing only when the optimum prediction mode is the inter prediction mode.

Further, the encoding device 10 may not transmit the intra application information and the inter application information, and the encoding device 10 may perform the sign data hiding processing and the decoding device 110 may perform the adding processing only when the optimum prediction mode is the inter prediction mode.

Further, the threshold may be changed according to whether the optimum prediction mode is the intra prediction mode or the inter prediction mode.

Note that the present technology can employ the following configurations.

(1)

An encoding device including:

an orthogonal transform unit configured to orthogonally transform a difference between an image to be encoded and a prediction image to generate orthogonal transform coefficients; and

a coefficient operation unit configured to apply, based on a sum of absolute values of non-zero orthogonal transform coefficients of the orthogonal transform coefficients generated by the orthogonal transform unit, sign data hiding processing of deleting a sign of a head non-zero orthogonal transform coefficient, and correcting the non-zero orthogonal transform coefficients such that a parity of the sum of absolute values of non-zero orthogonal transform coefficients becomes a parity corresponding to the sign, to the orthogonal transform coefficients.

(2)

The encoding device according to (1), further including:

a quantization unit configured to quantize the orthogonal transform coefficients subjected to the sign data hiding processing by the coefficient operation unit, using a quantization parameter; and

a setting unit configured to set a threshold to be used in the coefficient operation unit based on the quantization parameter, wherein

the coefficient operation unit performs the Sign Data Hiding processing when the sum of absolute values of non-zero orthogonal transform coefficients is larger than the threshold set by the setting unit.

(3)

The encoding device according to (2), further including:

a transmission unit configured to transmit the threshold corresponding to each quantization parameter.

(4)

The encoding device according to any of (1) to (3), wherein the coefficient operation unit performs the sign data hiding processing based on a prediction mode of the prediction image.

(5)

The encoding device according to (4), wherein the coefficient operation unit performs the sign data hiding processing when the prediction mode of the prediction image is an inter prediction mode.

(6)

The encoding device according to (4), further including:

a transmission unit configured to transmit inter application information indicating whether the coefficient operation unit performs the sign data hiding processing based on the sum of absolute values of non-zero orthogonal transform coefficients when the prediction mode of the prediction image is an inter prediction mode, and intra application information indicating whether the coefficient operation unit performs the sign data hiding processing based on the sum of absolute values of non-zero orthogonal transform coefficients when the prediction mode of the prediction image is an intra prediction mode.

(7)

The encoding device according to any of (1) to (6), wherein the orthogonal transform unit orthogonally transforms the difference to generate the orthogonal transform coefficients or outputs the difference as is without performing orthogonal transform, and

the coefficient operation unit applies the sign data hiding processing to the orthogonal transform coefficients based on the sum of absolute values of non-zero orthogonal transform coefficients when the difference is orthogonally transformed by the orthogonal transform unit.

(8)

The encoding device according to any of (1) to (5), further including:

a transmission unit configured to transmit application information indicating whether the coefficient operation unit performs the sign data hiding processing based on the sum of absolute values of non-zero orthogonal transform coefficients.

(9)

The encoding device according to any of (1) to (8), wherein the coefficient operation unit performs the sign data hiding processing based on the sum of absolute values of non-zero orthogonal transform coefficients in scan units of a time of the orthogonal transform.

(10)

An encoding method including:

by an encoding device,

an orthogonal transform step of orthogonally transforming a difference between an image to be encoded and a prediction image to generate orthogonal transform coefficients; and

a coefficient operation step of applying, based on a sum of absolute values of non-zero orthogonal transform coefficients of the orthogonal transform coefficients generated by processing of the orthogonal trans form step, sign data hiding processing of deleting a sign of a head non-zero orthogonal transform coefficient and correcting the non-zero orthogonal transform coefficients such that a parity of the sum of absolute values of non-zero orthogonal transform coefficients becomes a parity corresponding to the sign, to the orthogonal transform coefficients.

(11)

A decoding device including:

a sign decoding unit configured to apply, based on a sum of absolute values of non-zero orthogonal transform coefficients of orthogonal transform coefficients of a difference between an image to be decoded and a prediction image, adding processing of adding a sign corresponding to a parity of the sum of absolute values of non-zero orthogonal transform coefficients as a sign of a head non-zero orthogonal transform coefficient, to the orthogonal transform coefficients; and

an inverse orthogonal transform unit configured to inversely orthogonally transform the orthogonal transform coefficients subjected to the adding processing by the sign decoding unit.

(12)

The decoding device according to (11), further including:

an inverse quantization unit configured to inversely quantize the orthogonal transform coefficients quantized using a quantization parameter, using the quantization parameter; and

a setting unit configured to set a threshold to be used in the sign decoding unit based on the quantization parameter, wherein

the sign decoding unit performs the adding processing when the sum of absolute values of non-zero orthogonal transform coefficients of the orthogonal transform coefficients inversely quantized by the inverse quantization unit is larger than the threshold set by the setting unit.

(13)

The decoding device according to (12), further including:

a receiving unit configured to receive the threshold corresponding to each quantization parameter, wherein

the setting unit sets a threshold corresponding to the quantization parameter used by the inverse quantization unit, of the thresholds received by the receiving unit.

(14)

The decoding device according to any of (11) to (13), wherein the sign decoding unit performs the adding processing based on a prediction mode of the prediction image.

(15)

The decoding device according to (14), wherein the sign decoding unit performs the adding processing when the prediction mode of the prediction image is an inter prediction mode.

(16)

The decoding device according to (14), further including:

a receiving unit configured to receive inter application information indicating whether the adding processing is performed based on the sum of absolute values of non-zero orthogonal transform coefficients when the prediction mode of the prediction image is an inter prediction mode, and intra application information indicating whether the adding processing is performed based on the sum of absolute values of non-zero orthogonal transform coefficients when the prediction mode is the prediction image is an intra prediction mode, wherein

the sign decoding unit performs the adding processing based on the inter application information and the intra application information.

(17)

The decoding device according to any of (11) to (16), further including:

a receiving unit configured to receive the orthogonal transform coefficients or the difference, wherein

the sign decoding unit applies the adding processing to the orthogonal transform coefficients based on the sum of absolute values of non-zero orthogonal transform coefficients when the orthogonal transform coefficients have been received by the receiving unit.

(18)

The decoding device according to any of (11) to (15), further including:

a receiving unit configured to receive application information indicating whether the adding processing is performed based on the sum of absolute values of non-zero orthogonal transform coefficients, wherein

the sign decoding unit performs the adding processing based on the application information received by the receiving unit.

(19)

The decoding device according to any of (11) to (18), wherein the sign decoding unit performs the adding processing based on the sum of absolute values of non-zero orthogonal transform coefficients in scan units of a time of the orthogonal transform.

(20)

A decoding method including:

by a decoding device,

a sign decoding step of performing, based on a sum of absolute values of non-zero orthogonal transform coefficients of orthogonal transform coefficients of a difference between an image to be decoded and a prediction image, adding processing of adding a sign corresponding to a parity of the sum of absolute values of non-zero orthogonal transform coefficients as a sign of a head non-zero orthogonal transform coefficient, to the orthogonal transform coefficients; and

an inverse orthogonal transform step of inversely orthogonally transforming the orthogonal transform coefficients subjected to the adding processing by processing of the sign decoding step.

### REFERENCE SIGNS LIST

10 Encoding device
13 Transmission unit
34 Orthogonal transform unit
36 Quantization unit
39 Inverse quantization unit
40 Inverse orthogonal transform unit
41 Sign hiding decoding unit
73 Threshold setting unit
75 Coefficient operation unit
93 Threshold setting unit
95 Sign decoding unit
110 Decoding device
111 Receiving unit
133 Inverse quantization unit
134 Inverse orthogonal transform unit

1. An encoding device comprising:
an orthogonal transform unit configured to orthogonally transform a difference between an image to be encoded and a prediction image to generate orthogonal transform coefficients; and
a coefficient operation unit configured to apply, based on a sum of absolute values of non-zero orthogonal transform coefficients of the orthogonal transform coefficients generated by the orthogonal transform unit, sign data hiding processing of deleting a sign of a head non-zero orthogonal transform coefficient, and correcting the non-zero orthogonal transform coefficients such that a parity of the sum of absolute values of non-zero orthogonal transform coefficients becomes a parity corresponding to the sign, to the orthogonal transform coefficients.

2. The encoding device according to claim 1, further comprising:
a quantization unit configured to quantize the orthogonal transform coefficients subjected to the sign data hiding processing by the coefficient operation unit, using a quantization parameter; and
a setting unit configured to set a threshold to be used in the coefficient operation unit based on the quantization parameter, wherein
the coefficient operation unit performs the Sing Data Hiding processing when the sum of absolute values of non-zero orthogonal transform coefficients is larger than the threshold set by the setting unit.

3. The encoding device according to claim 2, further comprising:
a transmission unit configured to transmit the threshold corresponding to each quantization parameter.

4. The encoding device according to claim 1, wherein the coefficient operation unit performs the sign data hiding processing based on a prediction mode of the prediction image.

5. The encoding device according to claim 4, wherein the coefficient operation unit performs the sign data hiding processing when the prediction mode of the prediction image is an inter prediction mode.

6. The encoding device according to claim 4, further comprising:
a transmission unit configured to transmit inter application information indicating whether the coefficient operation unit performs the sign data hiding processing based on the sum of absolute values of non-zero orthogonal transform coefficients when the prediction mode of the prediction image is an inter prediction mode, and intra application information indicating whether the coefficient operation unit performs the sign data hiding processing based on the sum of absolute values of non-zero orthogonal transform coefficients when the prediction mode of the prediction image is an intra prediction mode.

7. The encoding device according to claim 1, wherein the orthogonal transform unit orthogonally transforms the difference to generate the orthogonal transform coefficients or outputs the difference as is without performing orthogonal transform, and
the coefficient operation unit applies the sign data hiding processing to the orthogonal transform coefficients based on the sum of absolute values of non-zero orthogonal transform coefficients when the difference is orthogonally transformed by the orthogonal transform unit.

8. The encoding device according to claim 1, further comprising:
a transmission unit configured to transmit application information indicating whether the coefficient operation unit performs the sign data hiding processing based on the sum of absolute values of non-zero orthogonal transform coefficients.

9. The encoding device according to claim 1, wherein the coefficient operation unit performs the sign data hiding processing based on the sum of absolute values of non-zero orthogonal transform coefficients in scan units of a time of the orthogonal transform.

10. An encoding method comprising:
by an encoding device,
an orthogonal transform step of orthogonally transforming a difference between an image to be encoded and a prediction image to generate orthogonal transform coefficients; and
a coefficient operation step of applying, based on a sum of absolute values of non-zero orthogonal transform coefficients of the orthogonal transform coefficients generated by processing of the orthogonal transform step, sign data hiding processing of deleting a sign of a head non-zero orthogonal transform coefficient and correcting the non-zero orthogonal transform coefficients such that a parity of the sum of absolute values of non-zero orthogonal transform coefficients becomes a parity corresponding to the sign, to the orthogonal transform coefficients.

11. A decoding device comprising:
a sign decoding unit configured to apply, based on a sum of absolute values of non-zero orthogonal transform coefficients of orthogonal transform coefficients of a difference between an image to be decoded and a prediction image, adding processing of adding a sign corresponding to a parity of the sum of absolute values of non-zero orthogonal transform coefficients as a sign of a head non-zero orthogonal transform coefficient, to the orthogonal transform coefficients; and
an inverse orthogonal transform unit configured to inversely orthogonally transform the orthogonal transform coefficients subjected to the adding processing by the sign decoding unit.

12. The decoding device according to claim 11, further comprising:
an inverse quantization unit configured to inversely quantize the orthogonal transform coefficients quantized using a quantization parameter, using the quantization parameter; and
a setting unit configured to set a threshold to be used in the sign decoding unit based on the quantization parameter, wherein
the sign decoding unit performs the adding processing when the sum of absolute values of non-zero orthogonal transform coefficients of the orthogonal transform coefficients inversely quantized by the inverse quantization unit is larger than the threshold set by the setting unit.

13. The decoding device according to claim 12, further comprising:
a receiving unit configured to receive the threshold corresponding to each quantization parameter, wherein
the setting unit sets a threshold corresponding to the quantization parameter used by the inverse quantization unit, of the thresholds received by the receiving unit.

14. The decoding device according to claim 11, wherein the sign decoding unit performs the adding processing based on a prediction mode of the prediction image.

15. The decoding device according to claim 14, wherein the sign decoding unit performs the adding processing when the prediction mode of the prediction image is an inter prediction mode.

16. The decoding device according to claim 14, further comprising:
a receiving unit configured to receive inter application information indicating whether the adding processing is performed based on the sum of absolute values of non-zero orthogonal transform coefficients when the prediction mode of the prediction image is an inter prediction mode, and intra application information indicating whether the adding processing is performed based on the sum of absolute values of non-zero orthogonal transform coefficients when the prediction mode is the prediction image is an intra prediction mode, wherein
the sign decoding unit performs the adding processing based on the inter application information and the intra application information.

17. The decoding device according to claim 11, further comprising:
a receiving unit configured to receive the orthogonal transform coefficients or the difference, wherein
the sign decoding unit applies the adding processing to the orthogonal transform coefficients based on the sum of absolute values of non-zero orthogonal transform coefficients when the orthogonal transform coefficients have been received by the receiving unit.

18. The decoding device according to claim 11, further comprising:
a receiving unit configured to receive application information indicating whether the adding processing is performed based on the sum of absolute values of non-zero orthogonal transform coefficients, wherein
the sign decoding unit performs the adding processing based on the application information received by the receiving unit.

19. The decoding device according to claim 11, wherein the sign decoding unit performs the adding processing based on the sum of absolute values of non-zero orthogonal transform coefficients in scan units of a time of the orthogonal transform.

20. A decoding method comprising:
by a decoding device,
a sign decoding step of performing, based on a sum of absolute values of non-zero orthogonal trans form coefficients of orthogonal transform coefficients of a difference between an image to be decoded and a prediction image, adding processing of adding a sign corresponding to a parity of the sum of absolute values of non-zero orthogonal transform coefficients as a sign of a head non-zero orthogonal transform coefficient, to the orthogonal transform coefficients; and
an inverse orthogonal transform step of inversely orthogonally transforming the orthogonal transform coefficients subjected to the adding processing by processing of the sign decoding step.
